(19) United States
(12) Patent Application Publication
(10) Pub. No.: US 2010/0191908 A1
(43) Pub. Date: Jul. 29, 2010

(54) Computer system and storage pool management method

(75) Inventor: Hiroshi Yamakawa, Yokohama (JP)

Correspondence Address: Juan Carlos A. Marquez;c/o Stites & Harbison PLLC, 1199 North Fairfax Street, Suite 900, Alexandria, VA, 22314-1437, US

(73) Assignee: Hitachi, Ltd.

(21) Appl. No.: 12/382,465

(22) Filed: Mar. 17, 2009

(30) Foreign Application Priority Data
Jan. 23, 2009 (JP) 2009-013355

(51) Int. Cl. G06F 12/00; G06F 12/02

(52) U.S. Cl. 711/114; 711/170; 711/E12.001; 711/E12.002

(57) ABSTRACT

Provided is a computer system comprising an application computer; a storage system which is coupled to the application computer, and which comprises at least one storage medium and a controller; and a management system which is coupled to the application computer and the storage system, and which comprises at least one computer. The management system monitors a capacity of the storage pool and transmits an allocation request to the storage system in a case where the capacity of the storage pool is equal to or smaller than a predetermined threshold value. The storage system allocates, in a case where the allocation request is received, a first logical storage area to the storage pool based on information included in the received allocation request. The management system displays information for judging whether or not the first certain logical storage area temporarily-allocated is to be associated with the storage pool.

### CLAIM OF PRIORITY

The present application claims priority from Japanese patent application 2009-13355 filed on Jan. 23, 2009, the content of which is hereby incorporated by reference into this application.

### BACKGROUND

This invention relates to facilitating, in a system which provides a thin provisioning volume with the use of a storage pool, management of the storage pool which is formed with various volumes having different properties, and more particularly, to a display method for storage pool information.

As a technology which enables improved capacity use efficiencies of physical disks provided to a storage device, such as HDDs and SSDs, “thin provisioning” is known.

Thin provisioning technology focuses on the fact that not the entire storage capacity of a logical volume (logical unit) is constantly in use by an application server. With respect to an area which is a storage area of a logical volume, but has received no writing from the application server, allocation of the storage area of a physical disk is prohibited, whereby the capacity use efficiency of the physical disk can be improved. It should be noted that a logical volume provided through the thin provisioning is referred to as a thin provisioning volume hereinbelow.

To describe the thin provisioning more specifically, when a thin provisioning volume is defined, no storage area of a physical disk (hereinbelow, may be referred to as physical storage area) is allocated to the entire storage area of that volume (hereinbelow, the storage area of a thin provisioning volume may be referred to as a virtual storage area) (the storage area of a physical disk may be allocated to a part of the storage area of that volume, but, even in such a case, there exists a storage area in the thin provisioning volume, which has received no allocation).

Then, after the storage device receives, from the application server, a write request with respect to a virtual storage area of the thin provisioning volume, to which no physical storage area is allocated, the storage device dynamically allocates an unused storage area of a storage pool (more exactly, unallocated physical storage area of a physical disk associated with a storage pool) to the virtual storage area of the thin provisioning volume, to which the write request has been made and no physical storage area is allocated, and then stores write data of the write request in the physical storage area.

Then, the allocated physical storage area is excluded from the unused storage area. It should be noted that a read request (or write request) with respect to a virtual storage area to which a physical storage area has been allocated is processed by the storage device performing reading (or writing) with respect to that physical storage area.

Here, a physical disk which provides the unused storage area is a physical disk allocated to (or associated with) a group called a storage pool. Further, instead of a physical disk, a logical volume constituted by a plurality of physical disks may be allocated to a storage pool.

As described above, the thin provisioning performs dynamic allocation of a physical storage area, and hence, if the unused storage area of the physical disk associated with the storage pool becomes exhausted (insufficient), the write request cannot be performed successfully.

In US 2008/0091748 A1, there is disclosed a technology intended to solve the failure of a write request to a thin provisioning volume, which is caused by a shortage of the unused storage area of a storage pool. In the technology disclosed in US 2008/0091748 A1, the capacity of the unused storage area of a storage pool is monitored, and, when the capacity falls below a predetermined value, a dedicated unused storage area which is defined in advance in the storage pool is consumed according to the priorities of applications performed by the application server, which uses the thin provisioning volume.

### SUMMARY

In the technology disclosed in US 2008/0091748, another unused storage area is prepared in advance in the storage pool for a case where the capacity of the unused storage area falls below the predetermined value. Accordingly, even when the capacity falls below the predetermined value, it is possible to avoid such a capacity shortage without requiring any administrative tasks of the administrator. However, it is necessary to allocate physical disks, which are normally unnecessary, to the storage pool in advance, and hence the use efficiencies of the physical disks are poor.

In view of the above-mentioned problem, this invention has been made, and it is therefore an object of this invention to facilitate appropriate operation and management of a storage pool.

A representative example of this invention is as follows. That is, there is provided a computer system comprising: a computer; a storage system; and a management computer, in which the management computer is configured to: detect a capacity shortage of a storage pool associated with a virtual volume provided by the storage system through thin provisioning; select, based on a predetermined criterion, a first logical volume which is not allocated to the storage pool to allocate the selected first logical volume to the storage pool; display, after allocation, information for selecting an alternative logical volume which is to be used in place of the first logical volume; receive a request which specifies, based on the displayed information, a logical volume which is to be used as the alternative logical volume; and allocate the alternative logical volume to the storage pool.

Another representative example of this invention is as follows. That is, there is provided a computer system, comprising: an application computer; a storage system which is coupled to the application computer, and which comprises at least one storage medium and a controller; and a management system which is coupled to the application computer and the storage system, and which comprises at least one computer, wherein the storage system is configured to: form array groups from the at least one storage medium; manage array groups correspondence relations between the at least one storage medium and the array groups; generate logical storage areas from the array groups; manage logical storage areas correspondence relations between the array groups and the logical storage areas; manage attributes of the at least one storage medium forming the array groups as attributes of the logical storage areas; manage storage pool correspondence relations between a storage pool, which is formed with a first one or more of the logical storage areas, and the first one or more of the logical storage areas; provide a virtual storage area to the application computer; and allocate a part of the first one or more of the logical storage areas, which is associated with the storage pool, to the virtual storage area in a case where a write request is received from the application computer, wherein the management system is configured to: periodically obtain, from the storage system, information on the array groups, the logical storage areas and the storage pool, the array groups correspondence relations, the logical storage areas correspondence relations, and the storage pool correspondence relations; associate second one or more of the logical storage areas, which is not associated with the storage pool, with an unused logical storage area group; monitor a capacity of the storage pool based on the obtained information on the storage pool; determine that the storage pool has run short of the capacity in a case where the capacity of the storage pool is equal to or smaller than a predetermined threshold value; select, from the unused logical storage area group, a first certain logical storage area which is to be temporarily allocated to the storage pool; and transmit, to the storage system, an allocation request including an identifier of the storage pool and an identifier of the first certain logical storage area, wherein the storage system is configured to: allocate, in a case where the allocation request is received, the first certain logical storage area to the storage pool based on information included in the received allocation request; and send to the management system a notification that the allocation has been finished, and wherein the management system, which has received the notification, is configured to: display information for judging whether or not the first certain logical storage area temporarily-allocated is to be associated with the storage pool; and associate the first certain logical storage area with the storage pool, update the storage pool correspondence relations, and display information indicating that the first certain logical storage area is associated with the storage pool in a case where an instruction to allow the first certain logical storage area to be associated with the storage pool is received.

Yet another representative example of this invention is as follows. That is, there is provided a storage pool management method used for a computer system, the computer system comprising: an application computer; a storage system coupled to the application computer; and a management computer coupled to the application computer and the storage system. The application computer comprises: a first processor; a first memory coupled to the first processor; and a first network interface coupled to the first processor. The management computer comprises: a second processor; a second memory coupled to the second processor; and a second network interface coupled to the second processor. The storage system comprises: at least one storage medium; and a controller for managing the storage medium. The controller comprises: a third processor; a third memory coupled to the third processor; a third network interface coupled to the third processor; and a disk interface coupled to the storage medium. The storage system is configured to: form an array group from the at least one storage medium; manage a correspondence relation between the storage medium and the array group; generate at least one logical storage area from the array group; manage a correspondence relation between the array group and the logical storage areas; manage attributes of the storage medium forming the array group as attributes of the logical storage area; manage a correspondence relation between a storage pool formed with a plurality of the logical storage areas and the logical storage areas; provide a virtual storage area to an application which is executed by the application computer; and allocate at least one of the logical storage areas included in the storage pool to the virtual storage area in a case where a write request is received from the application which is executed by the application computer. The storage pool management method includes the steps of: periodically obtaining, by the management computer, from the storage system, information on the array group, the logical storage area and the storage pool, and the correspondence relations thereof; managing, by the management computer, logical storage areas which are not associated with the storage pool as an unused logical storage area group; monitoring, by the management computer, a capacity of the storage pool based on the obtained information on the storage pool; determining, by the management computer, that the storage pool has run short of the capacity in a case where the capacity of the storage pool is equal to or smaller than a predetermined threshold value; transmitting, by the management computer, to the storage system, an allocation request which includes an identifier of the storage pool which has run short of the capacity, and an identifier of a logical storage area which is included in the unused logical storage area, and which is to be temporarily allocated to the storage pool which has run short of the capacity; allocating, by the storage system, in a case where the allocation request is received, the logical storage area included in the unused logical storage area to the storage pool which has run short of the capacity based on information included in the received allocation request; sending, by the storage system, to the management computer, a notification that the allocation has been finished; generating, by the management computer, which has received the notification, display information for judging whether or not the temporarily-allocated logical storage area is to be associated with the storage pool; associating, by the management computer, the temporarily-allocated logical storage area with the storage pool and updating the correspondence relation between the storage pool and the logical storage areas in a case where an instruction to allow the temporarily-allocated logical storage area to be associated with the storage pool is received; and transmitting, by the management computer, to the storage system, an association request which requests the temporarily-allocated logical storage area to be associated with the storage pool.

According to the representative aspects of this invention, it is possible to avoid the capacity shortage of the storage pool without decreasing use efficiencies of the physical disks.

### BRIEF DESCRIPTION OF THE DRAWINGS

The present invention can be appreciated by the description which follows in conjunction with the following figures, wherein:

FIG. 1 is a block diagram illustrating a configuration of a computer system according to a first embodiment of this invention;

FIG. 2 is a block diagram illustrating a functional configuration of the computer system according to the first embodiment of this invention;

FIG. 3 is a block diagram illustrating a management database according to the first embodiment of this invention;

FIG. 4 is an explanatory diagram illustrating a storage pool capacity monitoring table according to the first embodiment of this invention;

FIG. 5 is an explanatory diagram illustrating an unused volume pool management table according to the first embodiment of this invention;

FIG. 6 is an explanatory diagram illustrating a storage pool management table according to the first embodiment of this invention;

FIG. 7 is an explanatory diagram illustrating a data management table for storage pool registration according to the first embodiment of this invention;

FIG. 8 is a flow chart illustrating processing of a storage pool capacity monitoring program executed by a management server according to the first embodiment of this invention;

FIG. 9 is a flow chart illustrating processing of a storage pool expansion program executed by the management server according to the first embodiment of this invention;

FIG. 10 is a flow chart illustrating processing of a storage pool information displaying program executed by the management server according to the first embodiment of this invention is executed;

FIG. 11 is an explanatory diagram illustrating an example of a storage pool detailed information displaying screen according to the first embodiment of this invention;

FIG. 12 is a flow chart illustrating processing of a storage pool registration program executed by the management server according to the first embodiment of this invention;

FIG. 13 is an explanatory diagram illustrating an example of an alternative volume list according to the first embodiment of this invention;

FIG. 14 is a block diagram illustrating a functional configuration of the computer system according to a second embodiment of this invention;

FIG. 15 is a block diagram illustrating a management database according to the second embodiment of this invention;

FIG. 16 is an explanatory diagram illustrating an unused volume pool management table according to the second embodiment of this invention;

FIG. 17 is an explanatory diagram illustrating an unused area management table according to the second embodiment of this invention;

FIGS. 18A and 18B are flow charts each illustrating a storage pool capacity expansion processing according to the second embodiment of this invention; and

FIG. 19 is a flow chart illustrating a modification example of the storage pool capacity expansion processing according to the second embodiment of this invention.

### DETAILED DESCRIPTION OF THE PREFERRED EMBODIMENTS

### First Embodiment

First, an outline of this invention is described. It should be noted that the following description is merely an example, and does not limit the scope of the right of this invention.

In a storage device which provides a thin provisioning volume by using the storage area of a logical volume which is allocated to a storage pool, there may arise a case in which, when the storage pool has run short of an unused storage area, writing to the thin provisioning volume cannot be preformed successfully.

Therefore, a management server detects a sign of exhaustion before the unused storage area is actually exhausted, and allocates a new logical volume to the storage pool, whereby the unused storage area increases. When a logical volume is automatically added after the detection of such exhaustion, in order to avoid a decline in reading or writing performance of the thin provisioning volume, a logical volume having better performance is selected based on a predetermined principle.

However, physical disks forming a logical volume which is allocated automatically in the above-mentioned manner are inferior in reliability to physical disks forming a logical volume which has already been allocated to the storage pool. As a result of this, there is a fear of decreasing the reliability of the thin provisioning volume. Even in a case where the physical disks forming the automatically-allocated logical volume are superior in reliability or in performance to the physical disks forming the already-allocated logical volume, there remains a problem in terms of cost because excessive physical disks are required to be allocated.

Therefore, after the automatic allocation, the management server displays the physical property of the automatically-allocated logical volume and the physical property of the already-allocated logical volume.

Further, upon reception of an instruction, from the administrator, to search for an alternative to the automatically-allocated logical volume, the management server displays logical volumes which are not allocated to the storage pool and the physical properties of those logical volumes. Then, after receiving, from the administrator, designation of an alternative volume to be allocated as the alternative to the automatically-allocated logical volume, the management server allocates that alternative volume to the storage pool in place of the automatically-allocated logical volume.

Here, the physical property of a logical volume means a property relating to the performance, reliability, or cost of a logical volume, such as an rpm or storage capacity of a physical disk forming the logical volume, or other configurations of the physical disk.

Further, in a case where a logical volume is created from an array group which is formed with a plurality of physical disks using the RAID technology, the physical property may include the RAID level of the array group or the number of physical disks included in the array group.

Owing to the configuration described above, in a situation in which a storage pool is running short of the unused storage area, which requires an urgent response, it is possible to make a prompt improvement of the situation without causing erroneous operation from the administrator. In addition, it becomes possible to perform such operation that allocates a logical volume which matches the physical property of a logical volume which is already allocated to the storage pool before the automatic allocation.

It should be noted that the logical volume which is already allocated to the storage pool before the automatic allocation is applicable in both an operation situation in which the logical volumes have the same physical property, and an operation situation in which the logical volumes have different physical properties. Examples of the operation situation in which the logical volumes have different physical properties include a case in which a logical volume is forced to be formed using different physical drives because that logical volume is allocated to the storage pool at a different timing from the timing of the other logical volume, and a case in which a logical volume having a different physical property, such as a capacity, is forced to be used due to an unavoidable circumstance. However, the examples may include another operation situation than those described above.

Similarly, a logical volume or alternative volume which is to be allocated automatically does not have to be allocated to a particular storage pool before the automatic allocation, and the automatic allocation and alternative allocation described above may be performed with respect to a plurality of storage pools. Further, the following management is also applicable. The logical volume or alternative volume is not allocated to a particular storage pool before the automatic allocation so that the logical volume or alternative volume can be provided, in a case where there is no sign of a shortage of the unused storage area, to an application server as a logical volume without using the thin provisioning.

The outline of this invention has been described above. Hereinbelow, this invention is described in detail.

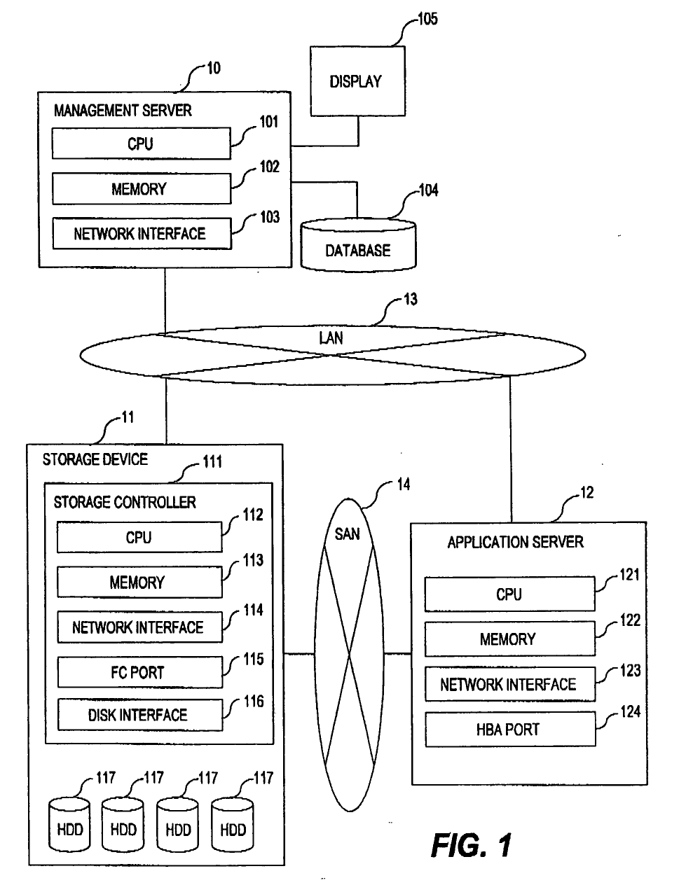

FIG. 1 is a block diagram illustrating a configuration of a computer system according to a first embodiment of this invention.

The computer system includes a management server 10, a storage device 11, an application server 12, a local area network (LAN) 13, and a storage area network (SAN) 14.

The LAN 13 is a network for coupling the management server 10, the storage device 11, and the application server 12 to one another. The SAN 14 is a network for coupling the storage device 11 and the application server 12.

The management server 10 is a computer which manages the storage device 11 and the application server 12. The management server 10 includes a CPU 101, a memory 102, and a network interface 103.

The CPU 101 performs various kinds of processing by executing a program loaded into the memory 102. The network interface 103 is an interface which is coupled to the storage device 11 and the application server 12 via the LAN 13.

The management server 10 is further coupled toga database 104 and a display 105. The database 104 stores information necessary for managing the storage device 11 and the application server 12. The display 105 is a screen for displaying information to a user.

The storage device 11 is a device which provides a storage area to the application server 12. The storage device 11 includes a storage controller 111 and a plurality of HDDs 117. The computer system may include a plurality of the storage devices 11 to use the plurality of the storage devices 11 collectively as a storage subsystem.

The storage controller 111 includes a CPU 112, a memory 113, a network interface 114, an FC port 115, and a disk interface 116.

The CPU 112 performs various, kinds of processing by executing a program loaded into the memory 113. The network interface 114 is an interface which is coupled to the management server 10 and the application server 12 via the LAN 13. The FC port 115 is an interface which is coupled to the application server 12 via the SAN 14. The disk interface 116 is an interface which is coupled to each HDD 117.

The application server 12 is a computer which executes an allocated task. The application server 12 includes a CPU 121, a memory 122, a network interface 123, and an HBA port 124. The computer system may include a plurality of the application servers 12 to use the plurality of the application servers 12 collectively as a server system.

The CPU 121 performs various kinds of processing by executing a program loaded into the memory 122. The network interface 123 is an interface which is coupled to the management server 10 and the storage device 11 via the LAN 13. The HBA port 124 is an interface which is coupled to the storage device 11 via the SAN 14.

It should be noted that the application server 12 does not necessarily have to be a computer which executes application processing, and may be a computer for another use. Similarly, the management server 10 may include another display device than the display 105, and also may include such input devices as a mouse and a keyboard. It should be noted that an input/output device of a computer which is coupled to the management server 10 as the display device (or output device) and the input device may be employed. In this case, management information which the management server 10 receives from an administrator is considered to be information which the management server 10 receives from that computer. Similarly, management information displayed by the management server 10 is considered to be information which the management server 10 transmits to that computer. It should be noted that the management server 10 may be a management system configured by at least one computer.

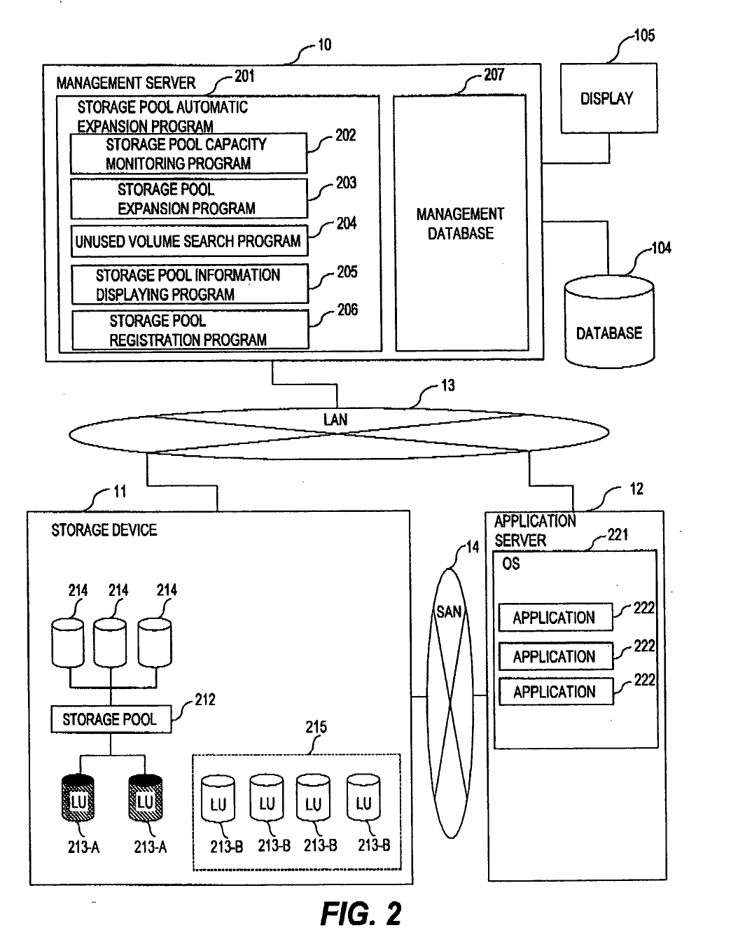

FIG. 2 is a block diagram illustrating a functional configuration of the computer system according to the first embodiment of this invention.

The storage controller 111 included in the storage device 11 manages at least one LU and at least one storage pool 212. It should be noted that the LU stands for logical unit, and is a logical volume. The storage controller 111 can define a plurality of storage pools 212, and also, can create a plurality of LUs. In the example of FIG. 2, the storage device 11 is provided with the storage pool 212, and is also provided with LUs 213-A which are associated with the storage pool 212 and LUs 213-B which are not associated with the storage pool 212. Hereinbelow, when the LU 213-A and the LU 213-B are not distinguished from each other, they are referred to as LU 213.

In the storage device 11, an arbitrary array group is formed with a plurality of HDDs 117, and, in the array group, at least one LU 213 is created. The storage controller 111 keeps information indicating a correspondence relation between the array group and the created LU 213. The information indicating the correspondence relation contains, for example, an identifier for identifying the array group, an identifier for identifying the LU 213, a RAID level, and information on the HDDs 117 forming the array group. It should be noted that the information on the HDDs 117 contains an interface type, an rpm, a capacity, a model number, and the like.

The storage controller 111 receives a storage pool addition request which contains an identifier for identifying a storage pool 212 and an identifier for identifying an LU 213, and, based on the received storage pool addition request, creates the storage pool 212. The storage pool addition request is transmitted from, for example, the management server 10. It should be noted that a plurality of storage pools 212 may be defined in the storage device.

The storage controller 111 keeps information indicating a correspondence relation between LU 213-A and storage pool 212. The information indicating the correspondence relation contains, for example, an identifier for identifying the storage pool 212, an identifier for identifying the LU 213, a capacity of the entire storage area of the storage pool 212, and a capacity of a storage area allocated to a virtual volume 214 (thin provisioning volume 214) described later.

In response to an inquiry made by the management server 10 about a free storage area of the storage pool 212, the storage controller 111 refers to the above-mentioned information indicating the correspondence relation between LU 213-A and storage pool 212, and then transmits information on the free storage area of the storage pool 212 to the management server 10. The information on the free storage area of the storage pool 212 may be information indicating a specific capacity amount of the free storage area, or may be information indicating a ratio of the used capacity to the capacity of the entire storage area. It should be noted that, at the time of an inquiry about the free storage area, the identifier of the storage pool 212 may be designated so that the storage device 11 can identify the inquiry target for the free storage area based on the designated identifier.

By referring to the above-mentioned information indicating the correspondence relation between LU 213-A and storage pool 212, the storage controller 111 can monitor the free storage area (hereinbelow, also referred to as capacity of unused storage area) of an LU 213-A, which is not allocated to any thin provisioning volume 214 (hereinafter, may be referred to as virtual volume 214) described below.

Further, the storage controller 111 keeps, for each storage pool 212, a threshold value for monitoring the capacity of the unused storage area of the storage pool 212, and, by using the threshold value, can judge whether or not the capacity of the unused storage area is insufficient. In other words, this processing detects a sign that a storage pool 212 is running short of the capacity of the unused storage area.

When a storage pool 212 has run short of the capacity of the unused storage area, the storage controller 111 may transmit, to the management server 10, an alert for providing a notification that the capacity of the unused storage area is insufficient. It should be noted that the alert contains at least an identifier for identifying the storage pool 212 which has run short of the capacity of the unused storage area.

The storage controller 111 provides at least one virtual volume 214 to the application server 12. It should be noted that the storage controller 111 may provide a plurality of virtual volumes 214 using one storage pool 212. Alternatively, virtual volumes 214 may be provided respectively by a plurality of storage pools 212 in a parallel manner. Hereinbelow, the virtual volume 214 is referred to as a thin provisioning volume 214.

The thin provisioning volume 214 is recognized by the application server 12 as a volume which has a larger virtual capacity than the capacity of the storage area (storage area which is actually available) of a logical volume actually allocated to the thin provisioning volume 214.

The storage controller 111 can add a necessary storage capacity to the thin provisioning volume 214 from the storage pool 212. The storage controller 111 keeps information indicating a correspondence relation between thin provisioning volume 214 and LU 213-A allocated to the thin provisioning volume 214. The information indicating the correspondence relation contains, for example, an address allocated to a storage area within the thin provisioning volume 214 and an address of the storage area of the LU 213-A allocated to the thin provisioning volume 214.

Upon reception of a write request from the application server 12, which requests writing into a given unallocated storage area of the thin provisioning volume 214, the storage controller 111 allocates the storage area of an LU 213-A associated with the storage pool 212 to the thin provisioning volume 214, and writes data in the allocated storage area of the LU 213-A.

It should be noted that the storage controller 111 registers the above-mentioned correspondence relation between thin provisioning volume 214 and LU 213-A allocated to the thin provisioning volume 214.

Upon reception of a write request from the application server 12, which requests writing into the storage area within the thin provisioning volume 214, the storage controller 111 uses the above-mentioned information indicating the correspondence relation between thin provisioning volume 214 and LU 213-A allocated to the thin provisioning volume 214 to thereby identify a given storage area of the LU 213-A from the storage area within the thin provisioning volume 214, and writes, into the storage area, the data requested to be written.

Upon reception of a read request from the application server 12, which requests reading from the storage area within the thin provisioning volume 214, the storage controller 111 uses the above-mentioned information indicating the correspondence relation between thin provisioning volume 214 and LU 213-A allocated to the thin provisioning volume 214 to thereby identify a given storage area of the LU 213-A from the storage area within the thin provisioning volume 214, and reads the data from the storage area, which is then transmitted to the application server 12.

Further, when a read request made by the application server 12 is a request to read from a thin provisioning volume 214 which is not allocated the storage area of an LU 213-A, the storage controller 111 transmits a predetermined value to the application server 12 as read data.

It should be noted that the storage controller 111 can allocate an LU 213 to the application server 12.

The processing described above is implemented by a storage pool management function provided to the storage device 11.

As described above, the storage device 11 keeps information regarding HDDs 117 made of physical disks, array groups, storage pools 212, LUs 213, and thin provisioning volumes 214. Hence, according to a request from the management server 10, the storage device 11 can extract necessary pieces of information and, after combining the extracted pieces of information, transmit the information to the management server 10. It should be noted that each piece of information is stored in the memory 113.

The management server 10 manages a plurality of LUs 213-B managed by the storage device 11 as an unused volume pool 215. By executing a program described below, the management server 10 allocates an LU 213-B included in the unused volume pool 215 to a storage pool 212 which has run short of the capacity of the unused storage area.

The memory 102 provided to the management server 10 stores a storage pool automatic expansion program 201 and a management database 207.

The storage pool automatic expansion program 201 includes a storage pool capacity monitoring program 202, a storage pool expansion program 203, an unused volume search program 204, a storage pool information displaying program 205, and a storage pool registration program 206.

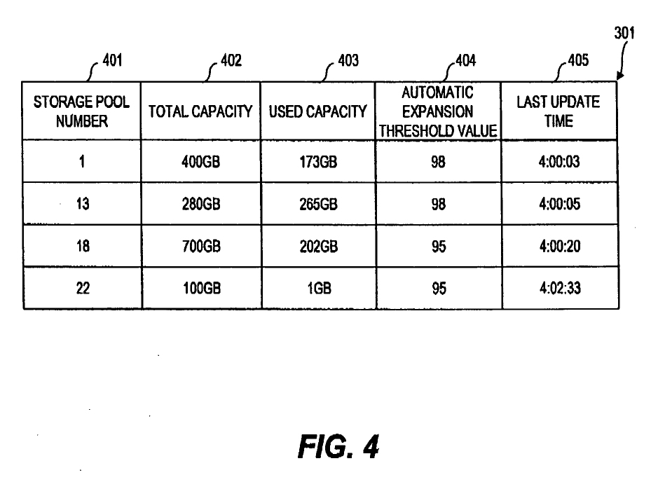

The storage pool capacity monitoring program 202 is a program for monitoring the capacity of the unused storage area (hereinafter, may be referred to as free capacity) of a storage pool 212. With this program, the management server 10 can manage a threshold value for automatic expansion, which is illustrated in FIG. 4.

The storage pool expansion program 203 is a program for expanding the capacity of a storage pool 212 which has run short of the free capacity. With this program, the management server 10 can appropriately expand the capacity of a storage pool 212, which has exceeded the threshold value for automatic expansion, which is illustrated in FIG. 4.

The unused volume search program 204 is a program for selecting an optimum LU 213-B from the unused volume pool 215. With this program, the management server 10 can allocate an optimum LU 213-B to the storage pool 212.

The storage pool information displaying program 205 is a program for displaying the features of LUs 213-A forming the storage pool 212 (or allocated to the storage pool 212) to the administrator in an understandable manner. With this program, the management server 10 can create information for displaying the features of the LUs 213-A forming the expanded storage pool 212 and display the created information on the display 105. It should be noted that the created information may be displayed to a device other than the display 105.

The storage pool registration program 206 is a program for adding an LU 213-B allocated by the storage pool expansion program 203 or an LU 213-B selected by the administrator as a constituent volume of the storage pool 212. With this program, the management server 10 can instruct the storage device 11 to add a given LU 213 to the storage pool 212.

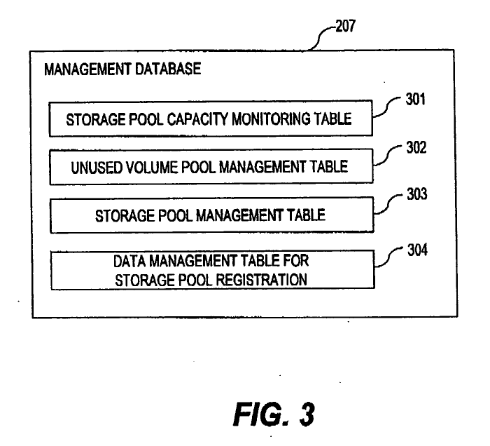

The management database 207 (hereinafter, may be referred to as storage management information 207) stores information necessary for executing each of the above-mentioned programs. The management database 207 is obtained by loading information stored in the database 104 into the memory 102. The management database 207 is described later in detail with reference to FIG. 3. It should be noted that the management database 207 can have a data structure other than a database.

The memory 122 provided to the application server 12 stores an OS 221, and a plurality of applications 222 are executed on the OS 221. The application server 12 performs various kinds of tasks by executing the applications 222.

FIG. 3 is a block diagram illustrating the management database 207 according to the first embodiment of this invention.

The management database 207 stores a storage pool capacity monitoring table 301, an unused volume pool management table 302, a storage pool management table 303, and a data management table for storage pool registration 304.

The storage pool capacity monitoring table 301 stores information for monitoring the free capacity (capacity of unused storage area) of the storage pool 212. It should be noted that the storage pool capacity monitoring table 301 is described later in detail with reference to FIG. 4.

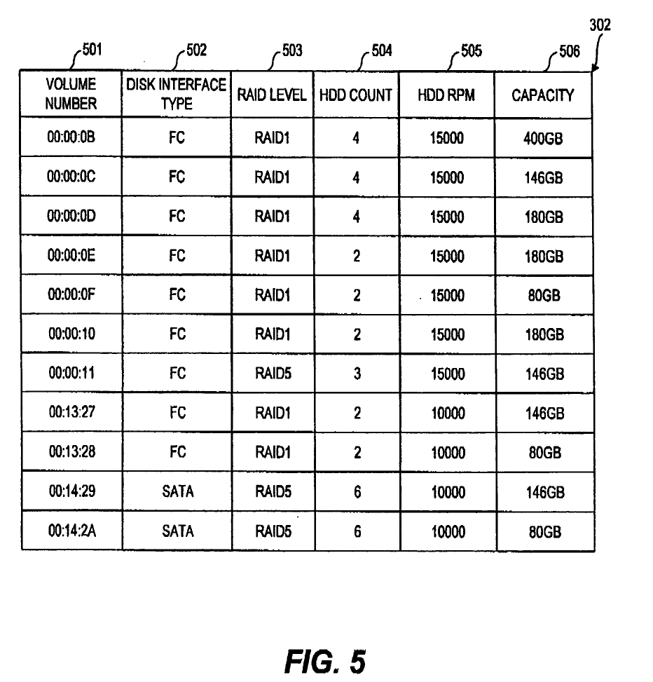

The unused volume pool management table 302 stores information on volumes available for expanding the storage pool 212, that is, information on LUs 213-B included in the unused volume pool 215. It should be noted that the unused volume pool management table 302 is described later in detail with reference to FIG. 5.

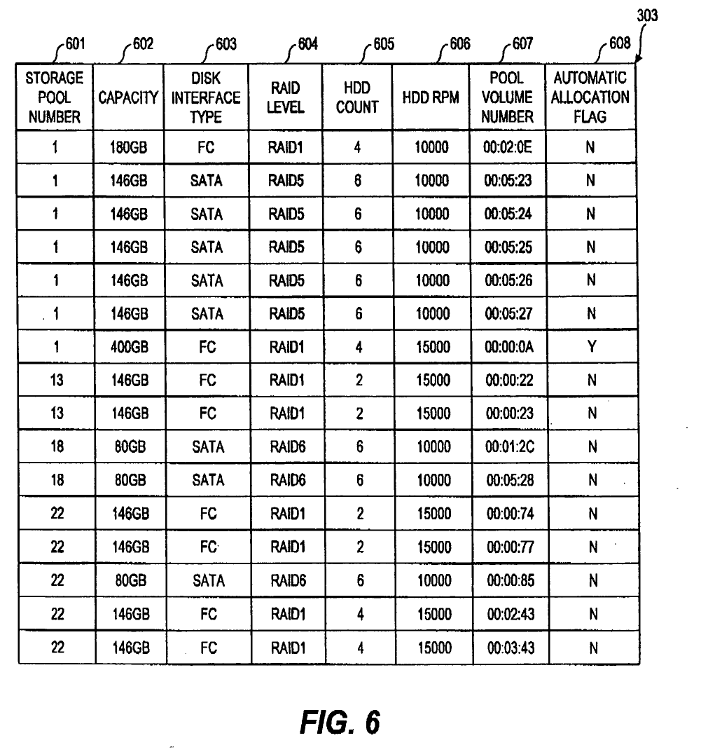

The storage pool management table 303 stores information on LUs 213-A forming the storage pool 212. It should be noted that the storage pool management table 303 is described later in detail with reference to FIG. 6.

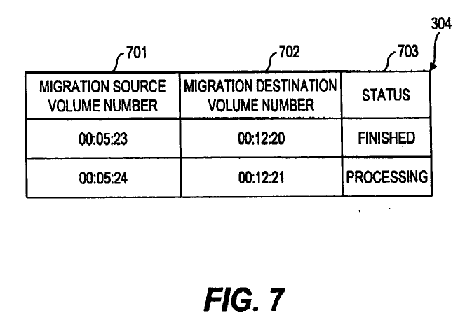

The data management table for storage pool registration 304 stores a status of such processing in which the management server 10 migrates data, which is stored in an LU 213-A temporarily allocated to the storage pool 212, to an LU 213-B selected by the administrator. It should be noted that the data management table for storage pool. registration 304 is described later in detail with reference to FIG. 7.

FIG. 4 is a diagram illustrating the storage pool capacity monitoring table 301 according to the first embodiment of this invention.

The storage pool capacity monitoring table 301 contains a storage pool number 401, a total capacity 402, a used capacity 403, an automatic expansion threshold value 404, and a last update time 405.

The storage pool number 401 stores an identifier for uniquely identifying a storage pool 212 which is defined within the storage device 11. The total capacity 402 stores a total capacity of the storage pool 212 corresponding to the storage pool number 401. The used capacity 403 stores a capacity, which is actually allocated to a thin provisioning volume 214, of the storage pool 212 corresponding to the storage pool number 401.

The automatic expansion threshold value 404 stores a threshold value used at the time of executing the storage pool capacity monitoring program 202 described later. In the example of FIG. 4, a ratio of the used capacity 403 to the total capacity 402 is stored. It should be noted that the automatic expansion threshold value 404 may store a used capacity, or may store a remaining capacity which is a difference between the total capacity 402 and the used capacity 403. The automatic expansion threshold value 404 may be any value as long as the management server 10 can detect a capacity shortage of the unused storage area.

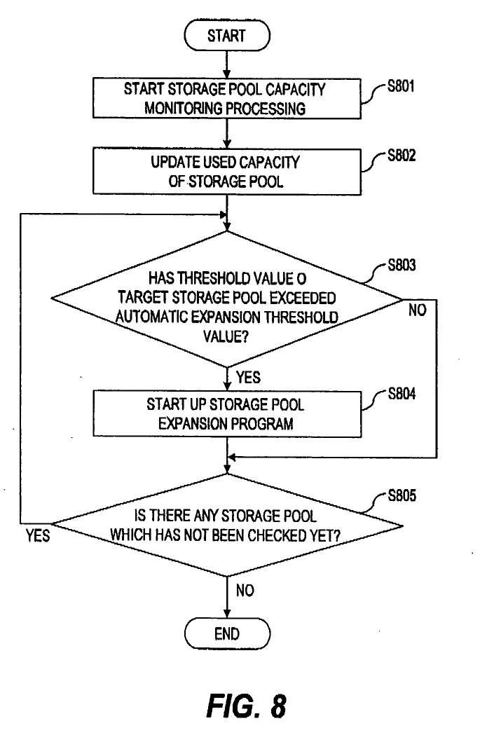

The last update time 405 stores a time at which whether a capacity runs short of the unused storage area of the storage pool 212 corresponding to the storage pool number 401 is confirmed. The last update time 405 may be any value as long as the value tells a time at which the management server 10 confirms whether a capacity runs short of the unused storage area of the storage pool 212. Accordingly, the last update time 405 may be a time used within the computer system, or may be an absolute time. It should be noted that a method of judging whether or not the storage pool 212 has run short of the capacity of the unused storage area is described later with reference to FIG. 8.

The storage pool capacity monitoring table 301 does not necessarily have to be a table structure, and can have another data structure as long as the storage pool capacity monitoring table 301 can store (or indicate), for each storage pool 212, at least one or all of the following items. Those are the total capacity (may be referred to as capacity of used storage area), the used capacity (may be referred to as capacity of unused storage area), the automatic expansion threshold value, and the last update time. It should be noted that the storage pool capacity monitoring table 301 may be referred to as storage pool capacity monitoring information 301.

FIG. 5 is a diagram illustrating the unused volume pool management table 302 according to the first embodiment of this invention.

The unused volume pool management table 302 contains a volume number 501, a disk interface type 502, a RAID level 503, an HDD count 504, an HDD rpm 505, and a capacity 506.

The volume number 501 stores an identifier for uniquely identifying an LU 213. Specifically, the volume number 501 stores an identifier for uniquely identifying an LU 213-B included in the unused volume pool 215. The disk interface type 502 stores a connection method of HDDs 117 actually creating the LU 213 corresponding to the volume number 501.

The RAID level 503 stores a RAID level of the array group to which the HDDs 117 creating the LU 213 corresponding to the volume number 501 belong. The HDD count 504 stores the number of HDDs 117 included in the array group which creates the LU 213 corresponding to the volume number 501.

The HDD rpm 505 stores rpms of HDDs 117 forming the array group which creates the LU 213 corresponding to the volume number 501. The capacity 506 stores a capacity of the LU 213 corresponding to the volume number 501.

It should be noted that the unused volume pool management table 302 does not necessarily have to be a table structure, and can have another data structure as long as the unused volume pool management table 302 can store (or indicate), for each LU, at least one or all of the following items. Those are the volume number, the disk interface type, the RAID level, the HDD count, the HDD rpm, and the capacity. Here, the unused volume pool management table 302 may be referred to as unused volume pool management information 302.

FIG. 6 is a diagram illustrating the storage pool management table 303 according to the first embodiment of this invention.

The storage pool management table 303 contains a storage pool number 601, a capacity 602, a disk interface type 603, a RAID level 604, an HDD count 605, an HDD rpm 606, a pool volume number 607, and an automatic allocation flag 608.

The storage pool number 601 stores an identifier for uniquely identifying a storage pool 212 defined in the storage device 11. The capacity 602 stores a capacity of an LU 213-A allocated to the storage pool 212 corresponding to the storage pool number 601. The disk interface type 603 stores a connection method of HDDs 117 actually creating an LU 213-A allocated to the storage pool 212 corresponding to the storage pool number 601.

The RAID level 604 stores a RAID level of the array group to which the HDDs 117 actually creating the LU 213-A allocated to the storage pool 212 corresponding to the storage pool number 601 belong. The HDD count 605 stores the number of HDDs 117 included in the array group to which the HDDs 117 actually creating the LU 213-A allocated to the storage pool 212 corresponding to the storage pool number 601 belong.

The HDD rpm 606 stores an rpm of the HDDs 117 actually creating the LU 213-A allocated to the storage pool 212 corresponding to the storage pool number 601. The pool volume number 607 stores an identifier for uniquely identifying the LU 213-A allocated to the storage pool 212 corresponding to the storage pool number 601.

The automatic allocation flag 608 stores an identifier for identifying whether or not an LU 213-A is an LU that has been newly allocated to the storage pool 212 by the management server 10. In the example of FIG. 6, the automatic allocation flag 608 having the entry of “Y” indicates that the LU 213-A is an LU that has been newly allocated to the storage pool 212 by the management server 10. Further, the automatic allocation flag 608 having the entry of “N” indicates that the LU 213-A is an LU that has already been allocated to the storage pool 212.

The automatic allocation flag 608 having the entry of “Y” indicates that the LU 213-A is an LU that has been temporarily allocated to the storage pool 212. The automatic allocation flag 608 having the entry of “N” indicates that the LU 213-A is an LU that has already been allocated to the storage pool 212.

In the example of FIG. 6, it is understood that an LU 213-A having the capacity 602 of “400 GB”, the disk interface type 603 of “FC”, the RAID level 604 of “RAID1”, the HDD count 605 of “4”, and the HDD rpm 606 of “15000” is allocated to the storage pool 212 having the storage pool number 601 of “1” with the pool volume number 607 being “00:00:0A”.

It should be noted that the capacity 602, the disk interface type 603, the RAID level 604, the HDD count 605, and the HDD rpm 606 may be managed as another table (information) along with the pool volume number 607. In this case, the another table can function in the same manner as the storage pool management table 303 by being searched based on the pool volume number 607.

It should be noted that the storage pool management table 303 does not necessarily have to be a table structure. Instead, the storage pool management table 303 can have another data structure as long as the storage pool management table 303 stores (or indicates), for LUs allocated to at least one storage pool defined in the storage device, at least one or all of the following items. Those are the storage pool number 601 indicating the storage pool to which the LU is allocated, the disk interface type 603, the RAID level 604, the HDD count 605, the HDD rpm 606, the pool volume number 607, and the automatic allocation flag 608. It should be noted that the storage pool management table 303 may be referred to as storage pool management information 303.

FIG. 7 is a diagram illustrating the data management table for storage pool registration 304 according to the first embodiment of this invention.

The data management table for storage pool registration 304 contains a migration source volume number 701, a migration destination volume number 702, and a status 703.

The migration source volume number 701 stores an identifier for uniquely identifying an LU 213-A which contains data to be migrated. The migration destination volume number 702 stores an identifier for uniquely identifying an LU 213-A which is to store the data to be migrated. The status 703 stores a processing status of data migration from the migration source LU 213-A to the migration destination LU 213-A.

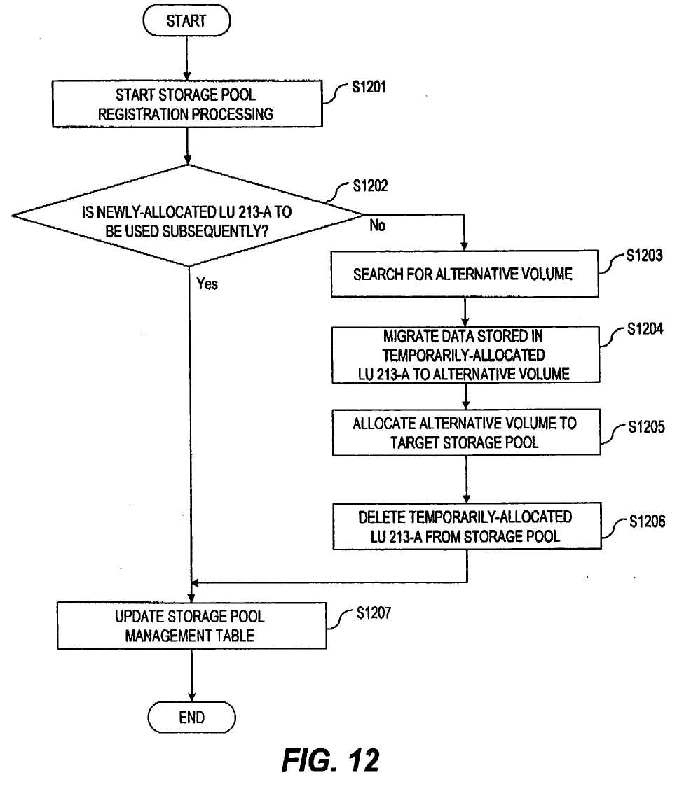

When processing of FIG. 12 described later is performed, a new entry is created in the data management table for storage pool registration 304. Further, an entry of the data management table for storage pool registration 304 is deleted at a given timing. For example, when the status 703 becomes “finished”, the entry is deleted.

It should be noted that the data management table for storage pool registration 304 can have another data structure as long as the data management table for storage pool registration 304 can store (or indicate) at least one or all of the following items. Those are the migration source volume number 701, the migration destination volume number 702, and the status 703. Here, the data management table for storage pool registration 304 may be referred to as data management information for storage pool registration 304.

FIG. 8 is a flow chart illustrating processing performed by the management server 10 when the storage pool capacity monitoring program 202 according to the first embodiment of this invention is executed.

The management server 10 periodically executes the storage pool capacity monitoring program 202 to start storage pool capacity monitoring processing (S801). It should be noted that the execution of the storage pool capacity monitoring program 202 may be performed when an instruction is given by the administrator.

The management server 10 updates the storage pool capacity monitoring table 301 (S802). Specifically, the management server 10 transmits to the storage device 11 a used capacity inquiry request for making an inquiry about the used capacities of all the storage pools 212 defined in the storage device 11.

The storage device 11 which has received the used capacity inquiry request refers to the information indicating the correspondence relation between LU 213-A and storage pool 212, and then transmits to the management server 10 a response which contains information on the used capacities of all the storage pools 212.

The management server 10, which has received the response, refers to the used capacities of all the storage pools 212, which are contained in the response, and then updates the used capacity 403 of the storage pool capacity monitoring table 301. Further, the management server 10 updates the last update time 405 of the storage pool capacity monitoring table 301.

Next, the management server 10 calculates a threshold value for each of the storage pools 212 by using the total capacity 402 and the used capacity 403 of the updated storage pool capacity monitoring table 301. In this embodiment, the ratio of the used capacity 403 to the total capacity 402 is used as a threshold value to be calculated. It should be noted that a remaining capacity or another value may be used as the threshold value to be calculated.

The management server 10 executes the following processing (S803 to S805) in ascending order of the storage pool number 401.

The management server 10 compares the threshold value of a target storage pool 212, which is calculated in S802, and the automatic expansion threshold value 404 of the target storage pool 212 (S803).

When it is judged that the threshold value of the target storage pool 212 calculated in S802 is smaller than the automatic expansion threshold value 404 of the target storage pool 212, the management server 10 proceeds to S805.

When it is judged that the threshold value of the target storage pool 212 calculated in S802 is larger than the automatic expansion threshold value 404 of the target storage pool 212, the management server 10 starts up the storage pool expansion program 203 so as to allocate a new LU 213-A to the target storage pool 212 (S804).

Next, the management server 10 judges whether or not there is any other storage pool 212 which has not been checked yet (S805).

When it is judged that there is a storage pool 212 which has not been checked yet, the management server 10 returns to S803, and executes the processing from S803 to S805.

When it is judged that there is no storage pool 212 which has not been checked yet, the management server 10 finishes the storage pool capacity monitoring processing.

With the processing described above, the management server 10 can automatically increase the free capacity of a storage pool 212 before the free capacity of the storage pool 212 is exhausted.

It should be noted that, in this embodiment, the management server 10 acquires the used capacities 403 of all the storage pools 212 at one time, but this invention is not limited thereto. For example, in S802, the management server 10 may acquire the used capacity of just one storage pool 212 from the storage device 11, and, after the execution of the processing from S802 to S805, may acquire the used capacity of the next storage pool 212 from the storage device 11.

Further, in addition to when the storage pool capacity monitoring processing is executed, the management server 10 may update the storage pool capacity monitoring table 301 repeatedly (e.g., at given time intervals).

Here, in a case where the storage device 11 is provided with a function of managing a threshold value for a storage pool and transmitting an alert to the management server 10 when the free capacity has become equal to or smaller than the threshold value, a threshold value which is to be managed by the storage device 11 may be set in advance, based on the value set in the automatic expansion threshold value 404, before this processing is started. With this configuration, the management server 10 receives such an alert that enables identifying a storage pool 212 which has run short of the free capacity, and then starts up the storage pool expansion program for the storage pool 212 about which a notification has been made by the alert, whereby the free capacity of the storage pool 212 can automatically increase.

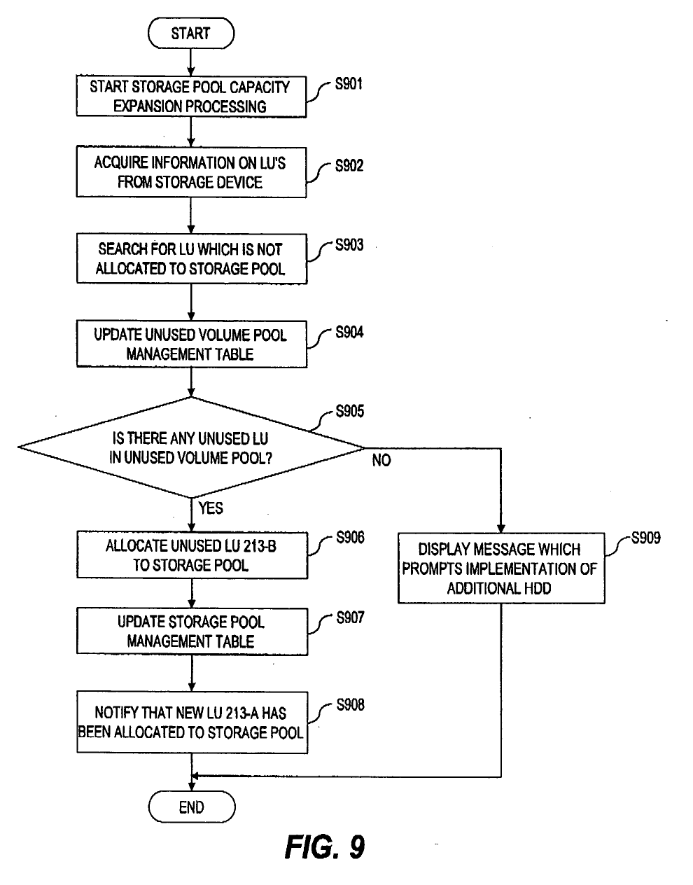

FIG. 9 is a flow chart illustrating processing performed by the management server 10 when the storage pool expansion program 203 according to the first embodiment of this invention is executed.

The management server 10 executes the storage pool expansion program 203 to start storage pool capacity expansion processing (S901).

The management server 10 acquires information on LUs 213 from the storage device 11 (S902). Specifically, the management server 10 transmits to the storage device 11 an LU inquiry request for making an inquiry about the information on LUs 213. The storage device 11, which has received the LU inquiry request, transmits to the management server 10 a response which contains information on all the LUs 213 managed by the storage device 11.

It should be noted that the response transmitted by the storage device 11 contains at least the volume number for identifying an LU 213, the information indicating the correspondence relation between LU 213 and storage pool 212, and information on HDDs 117 creating an LU 213 (disk interface type, HDD rpm, capacity, etc.).

The management server 10, which has received the response, stores the information on the LUs 213, which is contained in the response, in the database 104.

Next, the management server 10 searches for an LU 213 which is not allocated to the storage pool 212, in other words, searches for an LU 213-B (S903). Specifically, the management server 10 refers to the information on the LUs 213, which is stored in the database 104, and searches for an LU 213-B.

Here, as to the judgment whether or not an LU 213 is an LU 213-B, the following method is conceivable. For example, information regarding the correspondence relation between LU 213-A and storage pool 212 is referred to, and then an LU 213 which is not contained in the correspondence relation is judged to be an LU 213-B. Further, such a method that uses an identifier for indicating whether or not the LU 213 is an LU 213-A is also conceivable.

The management server 10 updates the unused volume pool management table 302 (S904). Specifically, the management server 10 updates the unused volume pool management table 302 based on the information on the LU 213-B retrieved in S903.

The management server 10 judges whether or not there is any unused LU 213, that is, any LU 213-B in the unused volume pool 215 (S905). Specifically, when there is no entry in the unused volume pool management table 302, the management server 10 judges that there is no unused LU 213 in the unused volume pool 215. Further, when there is at least one entry in the unused volume pool management table 302, the management server 10 judges that there is an unused LU 213 in the unused volume pool 215.

When it is judged that there is no unused LU 213 in the unused volume pool 215, the management server 10 displays on the display a message which prompts the storage device 11 to implement an additional HDD (S909), and then finishes the processing.

It should be noted that the administrator can also check the message which prompts the storage device 11 to implement an additional HDD by using a browser or the like on a computer (not shown) other than the management server 10 included in the computer system.

When it is judged that there is an unused LU 213 in the unused volume pool 215, the management server 10 allocates an LU 213-B included in the unused volume pool 215 to the storage pool 212 (S906).

Specifically, the management server 10 selects an LU 213-B to be allocated to the storage pool 212, and transmits to the storage device 11 a storage pool-LU allocation request for allocating the selected LU 213-B to the storage pool 212. That request contains at least the volume number 501 for uniquely identifying the selected LU 213-B and the storage pool number 401 for uniquely identifying the storage pool 212 to which the selected LU 213-B is to be allocated.

The storage device 11, which has received the storage pool-LU allocation request, allocates the selected LU 213-B to the storage pool 212 as a new LU 213-A based on the information contained in the storage pool-LU allocation request. Further, the storage device 11 updates the information indicating the correspondence relation between LU 213-A and storage pool 212. Then, the storage device 11 starts storing data of the storage area of the thin provisioning volume in the storage area of the specified LU 213-B. Further, the storage device 11 notifies the management server 10 that the allocation processing of the LU 213 has been completed.

Here, in S906, various methods are conceivable for selecting an LU 213-B to be allocated to the storage pool 212. Some examples are described below, but an LU 213-B may be selected based on another criterion than those examples described below.

### EXAMPLE 1

The management server 10 refers to the unused volume pool management table 302, and then selects an LU 213-B having the highest value as the HDD rpm 505. When there are a plurality of LUs 213-B having the highest value as the HDD rpm 505, the management server 10 selects an LU 213-B having the smallest value as the volume number 501. The HDD rpm has an influence on the average response time to a logical volume, and hence, by selecting such an LU 213-B, a decline in average response time in a thin provisioning volume, which results from the automatic addition, can be avoided or reduced.

### EXAMPLE 2

The management server 10 selects an LU 213-B based on the access property with respect to the storage pool 212.

### EXAMPLE 3

The management server 10 refers to the unused volume pool management table 302, and then selects an LU 213-B which has a RAID level provided with mirroring, such as RAID 1, or another RAID level which has high fault tolerance. By selecting such an LU 213-B, a decline in reliability of stored data in a thin provisioning volume, which results from the automatic addition, can be avoided or reduced.

### EXAMPLE 4

The management server 10 refers to the unused volume pool management table 302, and then selects an LU 213-B having the highest value as the HDD count 504. By selecting such an LU 213-B, a decline in IOPS in a thin provisioning volume, which results from the automatic addition, can be avoided or reduced.

### EXAMPLE 5

The management server 10 refers to the unused volume pool management table 302, and then selects an LU 213-B having the disk interface type of “FC”. By selecting such an LU 213-B, a decline in reliability of data stored in a thin provisioning volume, which results from the automatic addition, can be avoided or reduced.

Next, the management server 10 updates the storage pool management table 303 (S907). Specifically, the management server 10 transmits to the storage device 11 a storage pool-LU correspondence relation acquisition request for acquiring the information indicating the correspondence relation between LU 213-A and storage pool 212.

The storage device 11, which has received the storage pool-LU correspondence relation acquisition request, transmits to the management server 10 a response which contains the information indicating the correspondence relation between LU 213-A and storage pool 212. The management server 10, which has received the response, updates the storage pool management table 303 based on the information contained in the response.

The management server 10 makes a notification that a new LU 213-A has been allocated to the storage pool 212 (S908), and then finishes the processing. As notification means, for example, a method of using e-mail is conceivable.

It should be noted that, in S908, the management server 10 deletes the entry associated with the newly-allocated LU 213-A from the unused volume pool management table 302.

It should be also noted that S902, S903, and S904 may be executed separately from this processing so as to create/update the unused volume pool management table 302. In this case, those steps do not need to be executed at the time of executing the processing of FIG. 9, which is started when a capacity shortage is detected.

When the free capacity of the storage pool decreases to a large extent due to writing to the thin provisioning volume, there is a fear that the capacity is insufficient even if an LU 213-B having a small capacity is allocated automatically. In such a case, by executing the processing again to automatically allocate another LU 213-B again, it is possible to address the above-mentioned problem. However, when it is desired that the number of alerts transmitted from the storage device 11 or the number of notifications described below be reduced, the allocation of an unused LU 213-B may be performed repeatedly until a free capacity determined based on a predetermined criterion is attained. Such processing can be realized by referring to the capacity 506 of the unused volume pool management table 302.

The notification may contain a URL which enables the management server 10 to display detailed information on the storage pool 212 to which an LU 213-A has been allocated and on the newly-allocated LU 213-A.

The administrator uses the URL contained in the notification to display, on the display 105, the detailed information on the storage pool 212 to which an LU 213-A has been allocated, and on the newly-allocated LU 213-A.

Further, the administrator can also check the detailed information on the storage pool 212 to which an LU 213-A has been allocated, and on the newly-allocated LU 213-A by using a browser or the like on a computer (not shown) other than the management server 10 included in the computer system.

The LU 213-A automatically allocated to the storage pool 212 by the management server 10 is not always an appropriate LU 213, and hence the administrator needs to judge whether or not the allocated LU 213-A is an appropriate LU 213.

In this invention, in order to make the above-mentioned judgment possible, the management server 10 displays the detailed information on the storage pool 212 to which an LU 213-A has been allocated, and on the newly-allocated LU 213-A. With this configuration, the administrator can operate and manage the storage pool 212 more appropriately.

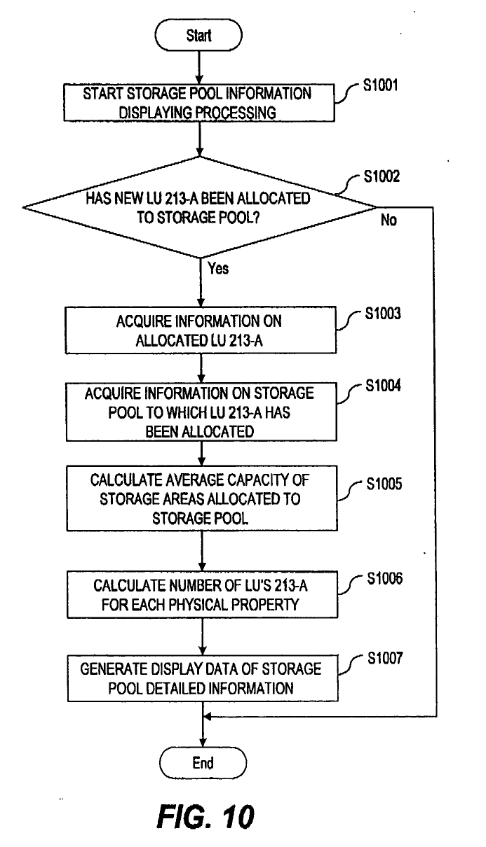

FIG. 10 is a flow chart illustrating processing performed by the management server 10 when the storage pool information displaying program 205 according to the first embodiment of this invention is executed.

The administrator, who have received a notification that an LU 213-A has been newly allocated to the storage pool 212 in S908, makes the management server 10 execute the storage pool information displaying program 205, whereby storage pool information displaying processing is started (S1001). For example, in S908, the administrator operates a button or the like for starting the processing, which is contained in the notification sent from the management server 10, whereby the storage pool information displaying processing is started. It should be noted that the storage pool information displaying program 205 may be executed by an administrator other than the administrator who receives the notification.

The management server 10 judges whether or not a new LU 213-A has been allocated to the storage pool 212 (S1002). Specifically, the management server 10 refers to the automatic allocation flag 608 of the storage pool management table 303. When there is any entry having “Y” as the automatic allocation flag 608, it is judged that a new LU 213-A has been allocated to the storage pool 212. On the other hand, when all the entries have “N” as the automatic allocation flag 608, it is judged that no new LU 213-A has been allocated to the storage pool 212.

When it is judged that no new LU 213-A has been allocated to the storage pool 212, the management server 10 finishes the processing.

When it is judged that a new LU 213-A has been allocated to the storage pool 212, the management server 10 acquires the information on the allocated LU 213-A (S1003). Specifically, the management server 10 refers to the storage pool management table 303, and then acquires the information on all the entries having “Y” as the automatic allocation flag 608.

Next, the management server 10 acquires the information on the storage pool 212 to which the new LU 213-A has been allocated (S1004). Specifically, the management server 10 refers to the storage pool number 601 of the information on the LU 213-A acquired in S1003, and then acquires, from the storage pool management table 303, the information on all the LUs 213-A allocated to the storage pool 212, to which the new LU 213-A belongs.

Next, the management server 10 calculates an average capacity of the storage areas allocated to the storage pool 212 (S1005).

Specifically, the management server 10 extracts, from the information acquired in S1003 and S1004, the capacities 602 of all the LUs 213-A. Next, the management server 10 adds together the extracted capacities 602 of all the LUs 213-A. In other words, the management server 10 calculates the total capacity of the storage pool 212. The management server 10 divides the calculated total capacity of the storage pool 212 by the number of the LUs 213-A allocated to the storage pool 212, whereby the average capacity is calculated.

Next, the management server 10 calculates the number of LUs 213-A for each physical property (S1006). Specifically, the management server 10 extracts physical properties from the information acquired in S1003 and S1004. Here, the physical properties to be extracted are the disk interface type 603, the RAID level 604, the HDD count 605, and the HDD rpm 606. Based on the extracted physical properties, the management server 10 classifies the LUs 213-A allocated to the storage pool 212, and then calculates the number of LUs 213-A which belong to each classification.

Next, the management server 10 generates display data of storage pool detailed information from the information acquired and calculated in S1003 to S1006 (S1007). Further, the management server 10 displays the generated display data on the display 105, and then finishes the processing. It should be noted that the generated display data is stored in the memory 102.

In this embodiment, the storage pool information displaying processing is started by an instruction from the administrator, but this invention is not limited thereto. For example, in S908, at the time of sending a notification that a new LU 213-A has been allocated to the storage pool 212, the management server 10 may start the storage pool information displaying processing. In this case, the notification sent in S908 contains a URL for displaying the storage pool detailed information, and the administrator uses the URL to display the storage pool detailed information. It should be noted that the administrator can also check the storage pool detailed information by using a browser or the like on a computer (not shown) other than the management server 10 included in the computer system.

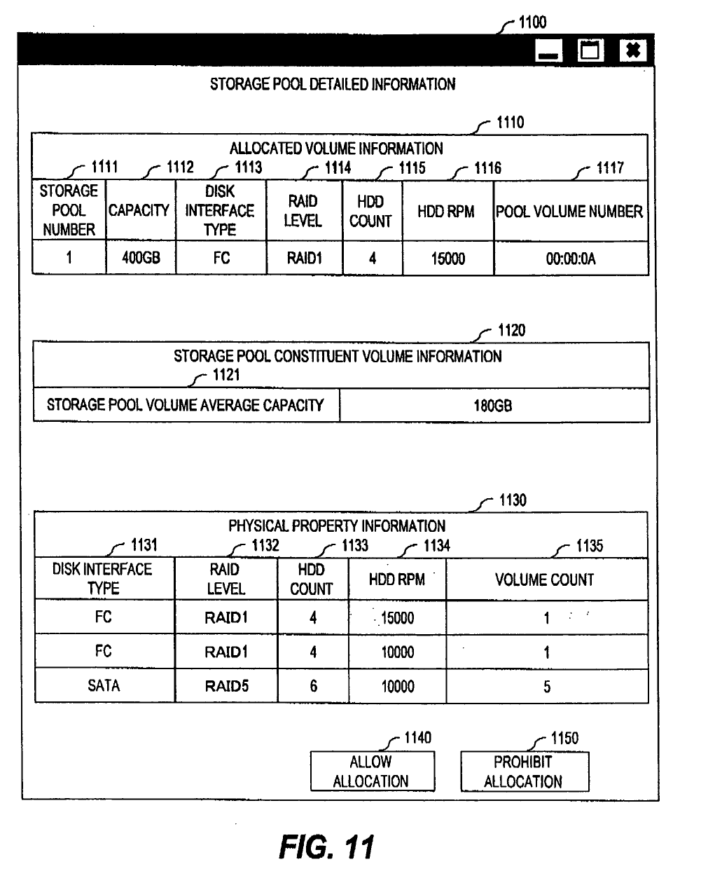

FIG. 11 is a diagram illustrating an example of a storage pool detailed information displaying screen 1100 according to the first embodiment of this invention.

The storage pool detailed information displaying screen 1100 displays allocated volume information 1110, storage pool constituent volume information 1120, physical property information 1130, “allow allocation” 1140, and “prohibit allocation” 1150.

The allocated volume information 1110 displays information on an LU 213-A which has been newly allocated to the storage pool 212. The allocated volume information 1110 contains a storage pool number 1111, a capacity 1112, a disk interface type 1113, a RAID level 1114, an HDD count 1115, an HDD rpm 1116, and a pool volume number 1117.

The above-mentioned pieces of information correspond to the storage pool number 601, the capacity 602, the disk interface type 603, the RAID level 604, the HDD count 605, the HDD rpm 606, and the pool volume number 607 of FIG. 6, respectively.

With this configuration, the administrator can check the detail of the newly-allocated LU 213-A.

The storage pool constituent volume information 1120 displays information on the storage pool 212. The storage pool constituent volume information 1120 contains a storage pool volume average capacity 1121.

The storage pool volume average capacity 1121 corresponds to the average capacity of the storage areas allocated to the storage pool 212, which is calculated in S1005.

It should be noted that the storage pool constituent volume information 1120 may contain information on the total capacity of the storage pool 212.

The physical property information 1130 classifies, by the physical property, the LUs 213-A forming the storage pool 212 to which an LU 213-A has been newly allocated, and then displays the number of LUs 213-A for each classification.

The physical property information 1130 contains a disk interface type 1131, a RAID level 1132, an HDD count 1133, an HDD rpm 1134, and a volume count 1135.

The disk interface type 1131, the RAID level 1132, the HDD count 1133, and the HDD rpm 1134 correspond to the disk interface type 603, the RAID level 604, the HDD count 605, and the HDD rpm 606, respectively.

The volume count 1135 represents the number of LUs 213-A classified by the disk interface type 1131, the RAID level 1132, the HDD count 1133, and the HDD rpm 1134.

With this configuration, the administrator can understand what physical properties the LUs 213-A forming the storage pool 212 have.

In the example of FIG. 11, the physical property information 1130 displays information obtained by combining the LU 213-A which has been newly allocated to the storage pool 212 and the LUs 213-A which have already been allocated to the storage pool 212.

It should be noted that the physical property information 1130 may be information displaying only the LUs 213-A which have already been allocated to the storage pool 212. With this configuration, it becomes easy to compare the LU 213-A which has been newly allocated to the storage pool 212 and the LUs 213-A which have already been allocated to the storage pool 212.

Incidentally, the example illustrated in FIG. 11 is merely one example, and some of the information pieces do not need to be contained. Further, those information pieces are desirably displayed in one window to make a comparison easier. However, an information display method, in which those information pieces are simultaneously displayed in separate windows or are displayed at different timings a plurality of times, may be adopted as long as those information pieces are displayed in association with one another. It should be noted that, though the following examples are conceivable as associated display, this invention is not limited thereto.

### DISPLAY EXAMPLE 1

The physical property information 1130 is not displayed, but a GUI object (operation button, character string, URL, picture, etc.) for displaying the corresponding physical property information 1130 is displayed in a first screen in which the allocated volume information 1110 is displayed. By selecting the object, the physical property information 1130 on the storage pool associated with that allocated volume information 1110 is displayed in a second screen. In other words, physical property information 1130 on another storage pool except for the associated storage pool is prohibited from being displayed in the second screen.

### DISPLAY EXAMPLE 2

A first window, in which the physical property information 1130 is not displayed but the allocated volume information 1110 is displayed, and a second window, in which the allocated volume information 1110 is not displayed but the physical property information 1130 is displayed, become on display at the same time.

The “allow allocation” 1140 is an operation button for allowing an LU 213-A which has been newly allocated to the storage pool 212 by the management server 10 to be used. The “prohibit allocation” 1150 is an operation button for prohibiting an LU 213-A which has been newly allocated to the storage pool 212 by the management server 10 from being used.

The administrator operates any one of the “allow allocation” 1140 and the “prohibit allocation” 1150, whereby storage pool registration processing illustrated in FIG. 12 described later is executed. From the perspective of the management server 10, that operation is regarded as reception of an allocation allowing request or an allocation prohibiting request.

FIG. 12 is a flow chart illustrating processing performed by the management server 10 when the storage pool registration program 206 according to the first embodiment of this invention is executed.

The administrator operates any one of the “allow allocation” 1140 and the “prohibit allocation” 1150 to execute the storage pool registration program 206, whereby the storage pool registration processing is started (S1201).

The management server 10 judges whether or not the newly-allocated LU 213-A is to be used subsequently (S1202). Specifically, when the “allow allocation” 1140 is operated, the management server 10 judges that the LU 213-A which has been newly allocated by the processing of FIGS. 8 and 9 is to be used subsequently. On the other hand, when the “prohibit allocation” 1150 is operated, the management server 10 judges that the newly-allocated LU 213-A is not to be used subsequently.

When it is judged, in S1202, that the newly-allocated LU 213-A is to be used subsequently, the management server 10 updates the storage pool management table 303 (S1207), and then finishes the processing. Specifically, the management server 10 updates the automatic allocation flag 608 of the entry corresponding to the newly-allocated LU 213-A from “Y” to “N” in the storage pool management table 303.

Further, the management server 10 instructs the storage device 11 to register the newly-allocated LU 213-A in the storage pool 212.

When it is judged, in S1202, that the newly-allocated LU 213-A is not to be used subsequently, the management server 10 refers to the unused volume pool management table 302 to search for a candidate LU 213-B (hereinbelow, referred to as alternative volume) (S1203). It should be noted that the LU 213-A allocated by the management server 10 has been deleted from the entries of the unused volume pool management table 302.

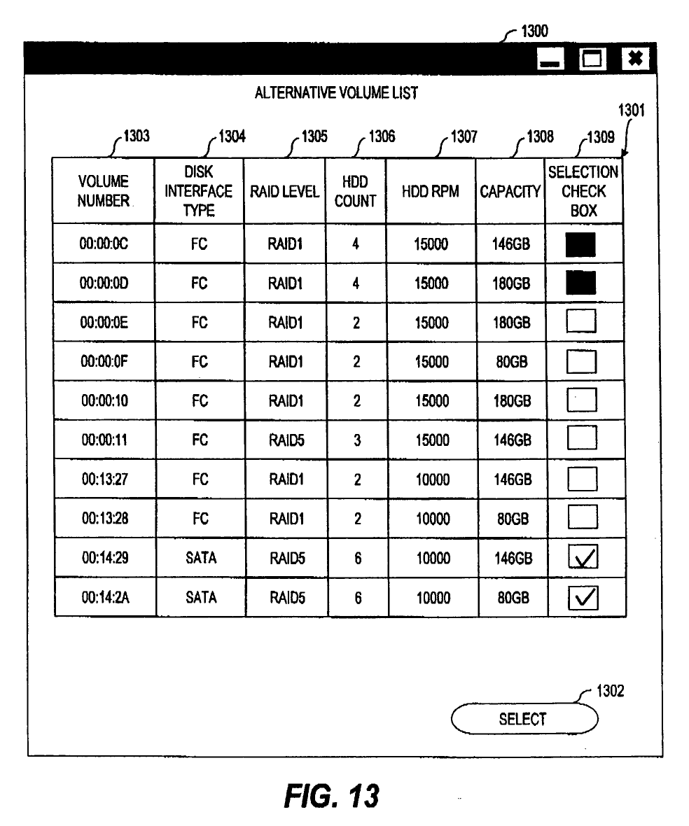

Specifically, the management server 10 acquires information on candidate LUs 213-B (alternative volumes) from the unused volume pool management table 302 to generate display data of an alternative volume list 1300 illustrated in FIG. 13, and displays the generated alternative volume list 1300 illustrated in FIG. 13. It should be noted that the alternative volume list 1300 is described later with reference to FIG. 13.

The administrator selects an arbitrary alternative volume from the alternative volume list 1300 illustrated in FIG. 13.

Next, the management server 10 migrates the data, which is stored in the LU 213-A temporarily allocated by the processing of FIGS. 8 and 9, to the alternative volume selected in S1203 (S1204). It should be noted that the data migration is executed by the storage device 11 which has received an instruction from the management server 10. In other words, the storage device 11 migrates the data stored in the temporarily-allocated LU 213-A to the selected alternative volume, and, along with this, updates the corresponding information.

The management server 10 allocates the alternative volume to the target storage pool 212 (S1205). Specifically, the management server 10 transmits to the storage device 11 an alternative volume allocation request for allocating the alternative volume to the storage pool 212. The request contains at least the volume number 501 for uniquely identifying the alternative volume and the storage pool number 401 for uniquely identifying the storage pool 212 to which the alternative volume is to be allocated.

The storage device 11, which has received the alternative volume allocation request, allocates the alternative volume to the storage pool 212 as a new LU 213-A based on the information contained in the alternative volume allocation request. Then, the storage device 11 updates the information indicating the correspondence relation between LU 213-A and storage pool 212. Further, the storage device 11 notifies the management server 10 that the allocation processing of the LU 213 has been completed.

The management server 10, which has received the notification from the storage device 11, registers the entry of the alternative volume in the storage pool management table 303, and then sets the automatic allocation flag 608 to “N”.

The management server 10 deletes, from the storage pool management table 303, the entry which corresponds to the LU 213-A temporarily allocated by the management server 10 (S1206), and proceeds to S1207.

It should be noted that, in S1204, the following processing may be performed instead of the data migration. The selected alternative volume is allocated to the storage pool 212, and, after that, the temporarily-allocated LU 213-A is deleted from the storage pool 212.

With the processing described above, an appropriate LU 213-A is allocated to the target storage pool 212.

FIG. 13 is a diagram illustrating an example of the alternative volume list 1300 according to the first embodiment of this invention.

The alternative volume list 1300 displays list information 1301 and “select” 1302. The list information 1301 contains a volume number 1303, a disk interface type 1304, a RAID level 1305, an HDD count 1306, an HDD rpm 1307, a capacity 1308, and a selection check box 1309.

The volume number 1303, the disk interface type 1304, the RAID level 1305, the HDD count 1306, the HDD rpm 1307, and the capacity 1308 correspond to the volume number 501, the disk interface type 502, the RAID level 503, the HDD count 504, the HDD rpm 505, and the capacity 506, respectively.

The selection check box 1309 is a check box for the administrator to select an alternative volume.

The selection check box 1309 may be configured so that an LU 213-B having the same physical property as that of an LU 213-A temporarily allocated by the management server 10 is prohibited from being selected. In the example of FIG. 13, the selection check boxes 1309 for two entries of the list information 1301 are prohibited from being selected. With this configuration, the administrator can select an LU 213-A having an appropriate physical property more accurately. Further, it is also applicable to prohibit displaying information on an LU 213-B which is a selection prohibited target.

The “select” 1302 is an operation button for allocating an entry, which has the selection check box 1309 checked, to the target storage pool 212.

According to the first embodiment of this invention, the management server 10 can automatically allocate an LU 213-A to a storage pool 212 in which the capacity of the unused storage area has become insufficient, and can display the physical property of the newly-allocated LU 213-A, and the status of the storage pool 212 which has been newly allocated the LU 213-A. With this configuration, the administrator can understand the status of a storage pool 212 accurately, and therefore can operate and manage storage pools 212 appropriately.

Further, when another LU 213-A than a temporarily-allocated LU 213-A is allocated to a storage pool 212, the management server 10 can make a notification that an LU 213-B having the same physical property as that of the temporarily-allocated LU 213-A cannot be selected. With this configuration, the administrator can allocate an appropriate LU 213-A to the storage pool 212.

### Second Embodiment

Next, a second embodiment of this invention is described.

The configuration of a computer system is the same as that of the first embodiment of this invention, and hence description thereof is omitted.

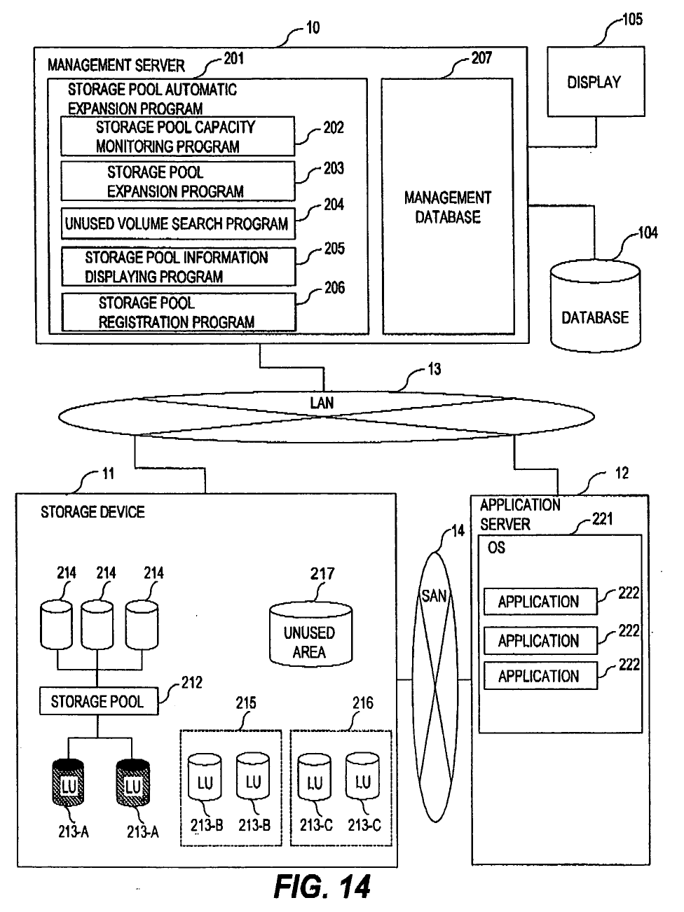

FIG. 14 is a block diagram illustrating a functional configuration of the computer system according to the second embodiment of this invention. Hereinbelow, a difference from the first embodiment of this invention is mainly described.

In the second embodiment of this invention, the management server 10 additionally manages an unregistered volume pool 216 and an unused area 217.

The unregistered volume pool 216 is a pool formed with LUs 213 which are not registered in the unused volume pool 215. Hereinbelow, an LU 213 which is included in the unregistered volume pool 216 is referred to as an LU 213-C.

The unused area 217 is a storage area of an array group which is not used as an LU 213.

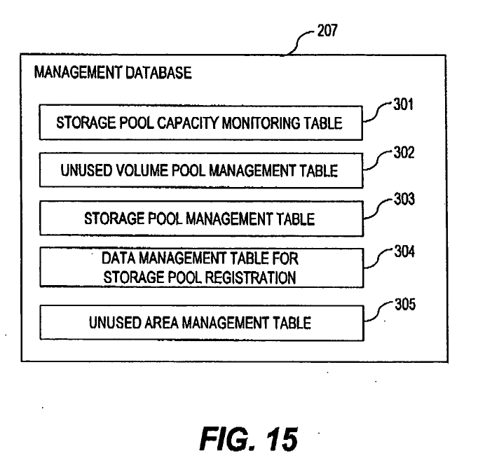

The management database 207 of the management server 10 stores a table for managing the unregistered volume pool 216 and the unused area 217. The management database 207 is described later in detail with reference to FIG. 15.

In the second embodiment of this invention, by creating in advance an LU 213-A to be allocated to the storage pool 212, it is possible to allocate an appropriate LU 213 to the storage pool 212.

FIG. 15 is a block diagram illustrating the management database 207 according to the second embodiment of this invention.

The management database 207 stores a storage pool capacity monitoring table 301, an unused volume pool management table 302, a storage pool management table 303, a data management table for storage pool registration 304, and an unused area management table 305.

The storage pool capacity monitoring table 301, the storage pool management table 303, and the data management table for storage pool registration 304 are the same as those of the first embodiment of this invention.

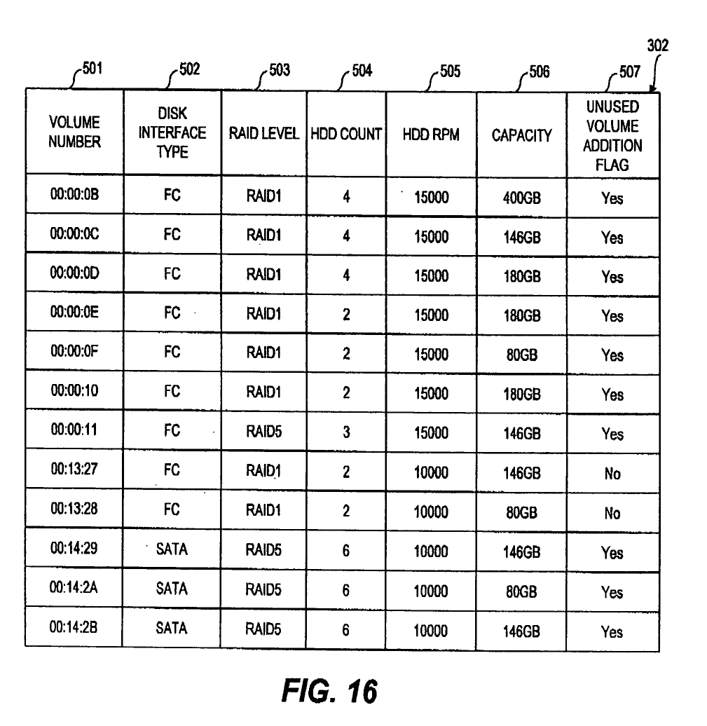

The unused volume pool management table 302 according to the second embodiment of this invention manages the unused volume pool 215 and the unregistered volume pool 216. The unused volume pool management table 302 is described later in detail with reference to FIG. 16.

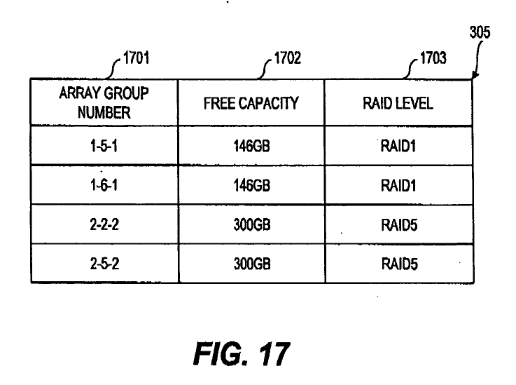

The unused area management table 305 stores information for managing the unused area 217. The unused area management table 305 is described later in detail with reference to FIG. 17.

FIG. 16 is a diagram illustrating the unused volume pool management table 302 according to the second embodiment of this invention.

A volume number 501, a disk interface type 502, a RAID level 503, an HDD count 504, an HDD rpm 505, and a capacity 506, which are contained in the unused volume pool management table 302, are the same as those of the first embodiment of this invention, respectively.

The unused volume pool management table 302 additionally contains an unused volume addition flag 507.

The unused volume addition flag 507 stores an identifier for identifying whether or not an LU 213 is an LU 213-B which has been added to the unused volume pool 215. In other words, the unused volume addition flag 507 stores an identifier for identifying whether an LU 213 is an LU 213-B included in the unused volume pool 215 or an LU 213-C included in the unregistered volume pool 216.

Specifically, when an LU 213 is an LU 213-B included in the unused volume pool 215, “Yes” is stored in the unused volume addition flag 507. On the other hand, when an LU 213 is an LU 213-C included in the unregistered volume pool 216, “No” is stored in the unused volume addition flag 507.

Due to the unused volume addition flag 507, the management server 10 can manage both the unused volume pool 215 and the unregistered volume pool 216.

FIG. 17 is a diagram illustrating the unused area management table 305 according to the second embodiment of this invention.

The unused area management table 305 contains an array group number 1701, a free capacity 1702, and a RAID level 1703.

The array group number 1701 stores an identifier for uniquely identifying an array group within the storage device 11.

The free capacity 1702 stores a value indicating the unused capacity of an array group associated with the array group number 1701. The RAID level 1703 stores the RAID level of an array group associated with the array group number 1701.

In the second embodiment of this invention, similarly to the first embodiment of this invention, the management server 10 executes storage pool capacity monitoring processing, storage pool capacity expansion processing, storage pool information displaying processing, and storage pool registration processing. Hereinbelow, the processing different from that of the first embodiment of this invention is mainly described.

The storage pool capacity monitoring processing, the storage pool information displaying processing, and the storage pool registration processing are the same as those of the first embodiment of this invention, and hence description thereof is omitted.

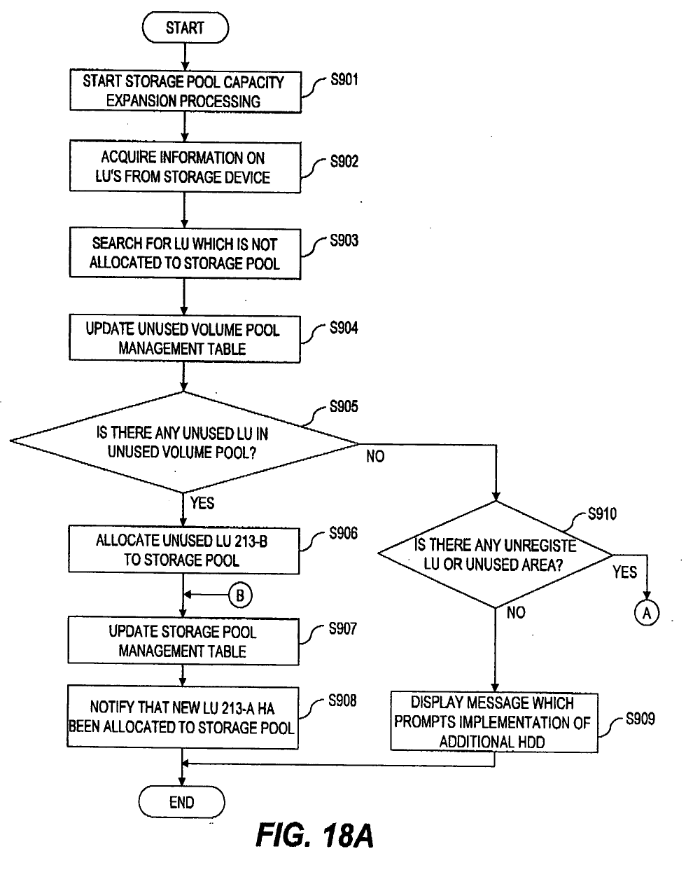

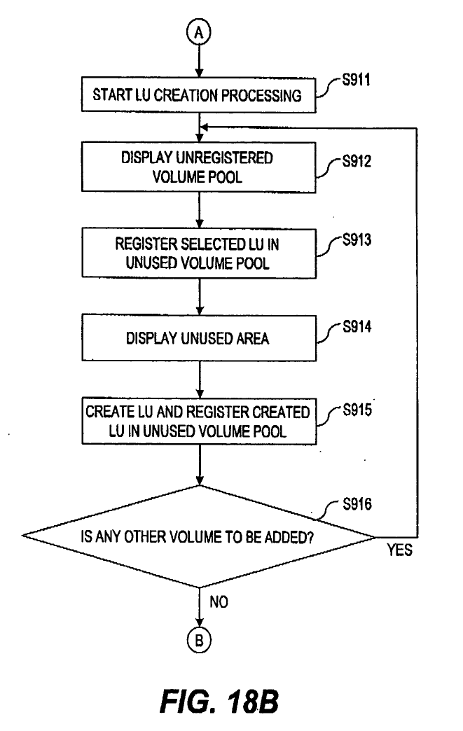

FIGS. 18A and 18B are flow charts illustrating the storage pool capacity expansion processing according to the second embodiment of this invention.

The management server 10 executes the storage pool expansion program 203 to start the storage pool capacity expansion processing (S901).

The processing from S901 to S909 is the same as that of the first embodiment of this invention. In this processing, after S905, the management server 10 judges whether or not there is any LU 213-C in the unregistered volume pool 216 or any unused area 217 (S910).

Specifically, the management server 10 refers to the unused volume pool management table 302 to judge whether or not there is any entry having “No” as the unused volume addition flag 507, and also refers to the unused area management table 305 to judge whether or not there is any entry in the unused area management table 305.

When it is judged that there is no LU 213-C in the unregistered volume pool 216 and no unused area 217, the management server 10 proceeds to S909.

When it is judged that there is an LU 213-C in the unregistered volume pool 216 or an unused area 217, the management server 10 starts LU creation processing (S911).

The management server 10 displays, to the administrator, LUs 213-C included in the unregistered volume pool 216 (S912). As a display method, a method of extracting and displaying LUs 213-C from the unused volume pool management table 302 is conceivable. The administrator selects an LU 213 to be registered in the unused volume pool 215 from among the displayed LUs 213-C.

The management server 10 registers the selected LU 213-C in the unused volume pool 215 (S913). Specifically, the unused volume addition flag 507 is changed from “No” to “Yes”. Further, the management server 10 transmits to the storage device 11 an LU registration request which contains the volume number 501 for identifying the selected LU 213-C and the storage pool number 401 for identifying the unused volume pool 215.

The storage device 11, which has received the LU registration request, registers the selected LU 213-C to the unused volume pool 215 based on the received registration request.

It should be noted that, when there is no LU 213-C, the management server 10 does not execute the processing of S912 or S913, and proceeds to S914.

The management server 10 displays the unused area 217 (S914). As a display method, a method of displaying information as illustrated in FIG. 17 is conceivable. The administrator selects an array group included in the displayed unused area 217.

The management server 10 creates an LU 213 from the selected array group, and then registers the created LU 213 in the unused volume pool 215 (S915).

The method for creating an LU 213 is as follows. When the administrator has selected an array group for creating an LU 213, the management server 10 displays a screen for inputting information necessary for creating an LU 213, and then transmits to the storage device 11 the information which has been input via the above-mentioned screen. The storage device 11, which has received the above-mentioned information, creates an LU 213 based on the received information. It should be noted that the method for creating an LU 213 is not limited to the above-mentioned method, and another method may be employed.

The management server 10 judges whether or not there is any other LU 213 to be added (S916). For example, after the processing of S915 has been finished, the management server 10 displays a result of the processing, in which an operation button for selecting whether or not the LU creation processing is to be continued is also displayed.

The management server 10 can judge, according to the operation of the above-mentioned operation button, whether or not there is any other LU 213 to be added.

When it is judged that there is another LU 213 to be added, the management server 10 returns to S912, and executes the same processing.

When it is judged that there is no other LU 213 to be added, the management server 10 finishes the LU creation processing, and proceeds to S907.

With the processing described above, the management server 10 can register an appropriate LU 213-A in the unused volume pool 215, and allocate an appropriate LU 213-A to a storage pool 212.

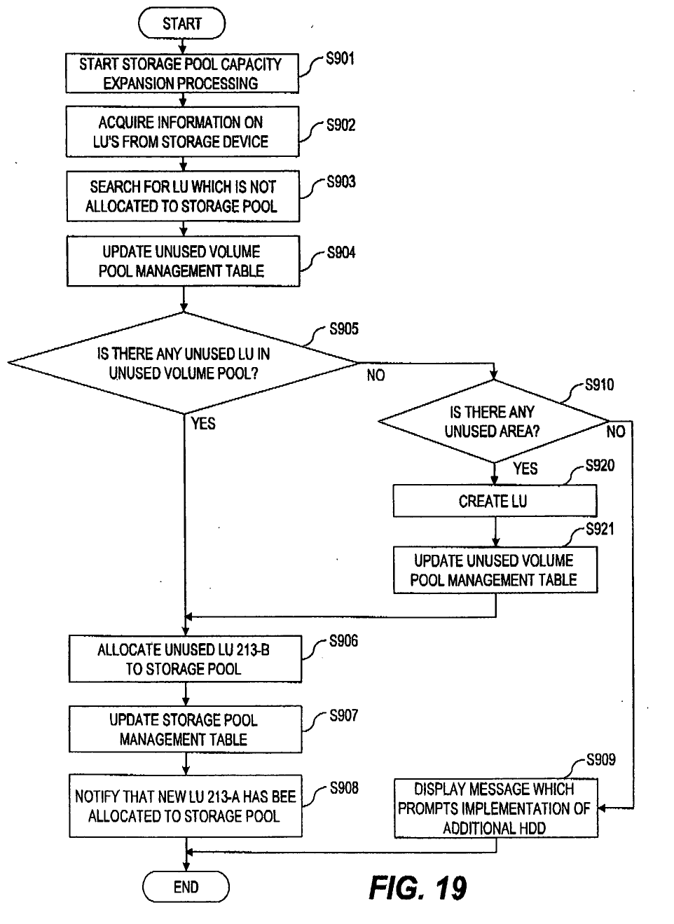

FIG. 19 is a flow chart illustrating a modification example of the storage pool capacity expansion processing according to the second embodiment of this invention.

The flow chart illustrates the storage pool capacity expansion processing which is performed when only the unused area 217 is present.

The processing from S901 to S908 is the same as that of the first embodiment of this invention.

In S910, the management server 10 judges whether or not there is any unused area 217. Specifically, the management server 10 refers to the unused area management table 305, and then judges whether or not there is any entry in the unused area management table 305.

When it is judged that there is no unused area 217, the management server 10 proceeds to S909.

When it is judged that there is an unused area 217, the management server 10 creates an LU 213 from the unused area 217 (S920). As the method for creating an LU 213, the same method as in S915 is employed. It should be noted that another method may be employed as the method for creating an LU 213.

The management server 10 registers the created LU 213 in the unused volume pool 215, and updates the unused volume pool management table 302 (S921). Then, the management server 10 proceeds to S906. Specifically, the management server 10 changes the unused volume addition flag 507 from “No” to “Yes”.

With this configuration, it is possible to allocate an appropriate LU 213-A to a storage pool 212 which has run short of the capacity of the unused storage area.

While the present invention has been described in detail and pictorially in the accompanying drawings, the present invention is not limited to such detail but covers various obvious modifications and equivalent arrangements, which fall within the purview of the appended claims.

What is claimed is:

1. A computer system, comprising:
an application computer;
a storage system which is coupled to the application computer, and which comprises at least one storage medium and a controller; and
a management system which is coupled to the application computer and the storage system, and which comprises at least one computer,
wherein the storage system is configured to:
form array groups from the at least one storage medium;
manage array groups correspondence relations between the at least one storage medium and the array groups;
generate logical storage areas from the array groups;
manage logical storage areas correspondence relations between the array groups and the logical storage areas;
manage attributes of the at least one storage medium forming the array groups as attributes of the logical storage areas;
manage storage pool correspondence relations between a storage pool, which is formed with a first one or more of the logical storage areas, and the first one or more of the logical storage areas;
provide a virtual storage area to the application computer; and
allocate a part of the first one or more of the logical storage areas, which is associated with the storage pool, to the virtual storage area in a case where a write request is received from the application computer,
wherein the management system is configured to:
periodically obtain, from the storage system, information on the array groups, the logical storage areas and the storage pool, the array groups correspondence relations, the logical storage areas correspondence relations, and the storage pool correspondence relations;
associate second one or more of the logical storage areas, which is not associated with the storage pool, with an unused logical storage area group;
monitor a capacity of the storage pool based on the obtained information on the storage pool;
determine that the storage pool has run short of the capacity in a case where the capacity of the storage pool is equal to or smaller than a predetermined threshold value;
select, from the unused logical storage area group, a first certain logical storage area which is to be temporarily allocated to the storage pool; and
transmit, to the storage system, an allocation request including an identifier of the storage pool and an identifier of the first certain logical storage area,
wherein the storage system is configured to:
allocate, in a case where the allocation request is received, the first certain logical storage area to the storage pool based on information included in the received allocation request; and
send to the management system a notification that the allocation has been finished, and
wherein the management system, which has received the notification, is configured to:
display information for judging whether or not the first certain logical storage area temporarily-allocated is to be associated with the storage pool; and
associate the first certain logical storage area with the storage pool, update the storage pool correspondence relations, and display information indicating that the first certain logical storage area is associated with the storage pool in a case where an instruction to allow the first certain logical storage area to be associated with the storage pool is received.

2. The computer system according to claim 1, wherein the management system is further configured to display a fact that the first certain logical storage area is temporarily allocated to the storage pool.

3. The computer system according to claim 2, wherein the management system is further configured to:
generate storage pool detailed information based on information on the first certain logical storage area, and information on the first one or more logical storage areas, which have been associated with the storage pool before the allocation of the first certain logical storage area; and
display the generated storage pool detailed information.

4. The computer system according to claim 3, wherein the management system is further configured to:
generate list information of logical storage areas associated with the unused logical storage area group for selecting a second certain logical storage area to be allocated to the storage pool in place of the first certain logical storage area temporarily-allocated in a case where an instruction to prohibit the first certain logical storage area from being associated with the storage pool is received; and
display the list information.

5. The computer system according to claim 4, wherein:
the storage pool detailed information includes attribute information for identifying attributes of the logical storage areas; and
the list information of the logical storage areas associated with the unused logical storage area group excludes a logical storage area having at least one attribute identical to at least one of attributes of the first certain logical storage area temporarily-allocated.

6. The computer system according to claim 1,
wherein the management system is further configured to:
manage, as an unregistered logical storage area, a logical storage area which is not associated with the storage pool, and which is not associated with the unused logical storage area group; and
in a case where no logical storage area is temporarily allocated to the storage pool which has run short of the capacity, transmit to the storage system a first logical storage area registration request that includes an identifier of the storage pool which has run short of the capacity, and an identifier of a logical storage area which is managed as the unregistered logical storage area, and which has at least one attribute identical to at least one of attributes of the first one or more of logical storage areas forming the storage pool which has run short of the capacity, and
wherein the storage system is further configured to register the logical storage area which has the at least one attribute identical to the at least one of the attributes of the first one or more logical storage areas forming the storage pool which has run short of the capacity, as the unused logical storage area according to the received first logical storage area registration request.

7. The computer system according to claim 6,
wherein the management system is further configured to:
further manage a storage area of the array group, which is not used as the logical storage areas as an unused area;
retrieve an array group which is included in the unused area, and which has the at least one attribute identical to the at least one of the attributes of the logical storage areas forming the storage pool which has run short of the capacity, in a case where no first logical storage area is temporarily allocated to the storage pool which has run short of the capacity, and in a case where no logical storage area managed as the unregistered logical storage area is present, and
transmit, to the storage system, a logical storage area generation request which includes an identifier of the retrieved array group,
wherein the storage system is further configured to generate a logical storage area from the retrieved array group according to the logical storage area generation request,
wherein the management system is further configured to transmit, to the storage system, a second logical storage area registration request which includes an identifier of the generated logical storage area and an identifier of the unused logical storage area, and
wherein the storage system is further configured to register the generated logical storage area in the unused logical storage area group according to the received second logical storage area registration request.

8. A storage pool management method used for a computer system, the computer system comprising: an application computer; a storage system coupled to the application computer; and a management system coupled to the application computer and the storage system, wherein:
the application computer comprises: a first processor; a first memory coupled to the first processor; and a first network interface coupled to the first processor,
the management system comprises: a second processor; a second memory coupled to the second processor; and a second network interface coupled to the second processor,
the storage system comprises: at least one storage medium; and a controller for managing the storage medium,
the controller comprises: a third processor; a third memory coupled to the third processor; a third network interface coupled to the third processor; and a disk interface coupled to the storage medium,
the storage system is configured to:
form array groups from the at least one storage medium;
manage array groups correspondence relations between the at least one storage medium and the array groups;
generate logical storage areas from the array groups;
manage logical storage areas correspondence relations between the array groups and the logical storage areas;
manage attributes of the at least one storage medium forming the array groups as attributes of the logical storage areas;
manage storage pool correspondence relations between a storage pool, which is formed with a first one or more of the logical storage areas, and the first one or more of the logical storage areas;
provide a virtual storage area to an application which is executed by the application computer; and
allocate a part of the first one or more of the logical storage areas, which is associated with the storage pool, to the virtual storage area in a case where a write request is received from the application which is executed by the application computer,
the storage pool management method includes the steps of:
periodically obtaining, by the management system, from the storage system, information on the array groups, the logical storage areas and the storage pool, the array groups correspondence relations, the logical storage areas correspondence relations, and the storage pool correspondence relations;
associating, by the management system, second one or more of the logical storage areas which is not associated with the storage pool as an unused logical storage area group;
monitoring, by the management system, a capacity of the storage pool based on the obtained information on the storage pool;
determining, by the management system, that the storage pool has run short of the capacity in a case where the capacity of the storage pool is equal to or smaller than a predetermined threshold value;
transmitting, by the management system, to the storage system, an allocation request which includes an identifier of the storage pool which has run short of the capacity, and an identifier of a certain logical storage area which is associated with the unused logical storage area group, and which is to be temporarily allocated to the storage pool which has run short of the capacity;
allocating, by the storage system, in a case where the allocation request is received, the certain logical storage area associated with the unused logical storage area group to the storage pool which has run short of the capacity based on information included in the received allocation request;
sending, by the storage system, to the management system, a notification that the allocation has been finished;
generating, by the management system, which has received the notification, display information for judging whether or not the certain temporarily-allocated logical storage area is to be associated with the storage pool;
associating, by the management system, the certain temporarily-allocated logical storage area with the storage pool and updating the storage pool correspondence relations in a case where an instruction to allow the certain temporarily-allocated logical storage area to be associated with the storage pool is received; and
transmitting, by the management system, to the storage system, an association request which requests the certain temporarily-allocated logical storage area to be associated with the storage pool.

9. The storage pool management method according to claim 8, further including the step of sending, by the management system, a notification that the certain logical storage area is temporarily allocated to the storage pool which has run short of the capacity.

10. The storage pool management method according to claim 9, further including the steps of:
generating, by the management system, storage pool detailed information based on information on the certain temporarily-allocated logical storage area, and information on the first one or more logical storage areas, forming the storage pool to which the certain logical storage area is temporarily allocated; and
generating, by the management system, information for displaying the generated storage pool detailed information.

11. The storage pool management method according to claim 10, further including the steps of:
generating, by the management system, a list of logical storage areas which can be newly allocated to the storage pool from the unused logical storage area group in a case where an instruction to prohibit the certain temporarily-allocated logical storage area from being associated with the storage pool is received; and
generating, by the management system, information for displaying the generated list of the logical storage areas which are associated with the unused logical storage area group.

12. The storage pool management method according to claim 11, wherein:
the storage pool detailed information includes attributes of the logical storage areas; and
the list of the logical storage areas which are associated with the unused logical storage area group excludes a logical storage area having at least one attribute identical to at least one of attributes of the certain temporarily-allocated logical storage area.

13. The storage pool management method according to claim 8, further including the steps of:
managing, by the management system, a logical storage area, which is not associated with the storage pool, and which is not associated with the unused logical storage area group, as an unregistered logical storage area group;
transmitting, by the management system, in a case where no logical storage area is temporarily allocated to the storage pool which has run short of the capacity, to the storage system, a first logical storage area registration request which includes an identifier of the storage pool which has run short of the capacity, and an identifier of a logical storage area which is managed as the unregistered logical storage area, and which has at least one attribute identical to at least one of attributes of the first one or more of logical storage areas forming the storage pool which has run short of the capacity, and
registering, by the storage system, the logical storage area which has the at least one attribute identical to the at least one of the attributes of the first one or more logical storage areas forming the storage pool which has run short of the capacity, as the unused logical storage area according to the received first logical storage area registration request.

14. The storage pool management method according to claim 13, further including the steps of:
further managing, by the management system, a storage area of the array group, which is not used as the logical storage areas, as an unused area;
retrieving, by the management system, an array group which is associated with the unused area, and which has the at least one attribute identical to the at least one of the attributes of the logical storage areas forming the storage pool which has run short of the capacity in a case where no logical storage area is temporarily allocated to the storage pool which has run short of the capacity, and in a case where no logical storage area managed as the unregistered logical storage area is present;
transmitting, by the management system, to the storage system, a logical storage area generation request which includes an identifier of the retrieved array group;
generating, by the storage system, a logical storage area from the retrieved array group according to the logical storage area generation request;
transmitting, by the management system, to the storage system, a second logical storage area registration request which includes an identifier of the generated logical storage area and an identifier of the unused logical storage area; and
registering, by the storage system, the generated logical storage area in the unused logical storage area group according to the received second logical storage area registration request.

15. A computer system, comprising:
an application server;
a storage device coupled to the application server; and
a management server coupled to the application server and the storage device, wherein:
the application server comprises:
a first processor;
a first memory coupled to the first processor; and
a first network interface coupled to the first processor;
the management server comprises:
a second processor;
a second memory coupled to the second processor; and
a second network interface coupled to the second processor;
the storage device comprises:
at least one magnetic disk drive; and
a storage controller for managing the magnetic disk drive;
the storage controller comprises:
a third processor;
a third memory coupled to the third processor;
a third network interface coupled to the third processor; and
a disk interface coupled to the magnetic disk drive;
the management server is coupled to a display;
the storage device is configured to:
form array groups from the at least one magnetic disk drive;
manage array groups correspondence relations between the at least one magnetic disk drive and the array groups;
generate logical units from the array groups;
manage logical units correspondence relations between the array groups and the logical units;
manage physical properties of the at least one magnetic disk drive forming the array groups as physical properties of the logical units;
manage storage pool correspondence relations between a storage pool, which is formed with a first one or more of the logical units, and the first one or more of the logical units;
provide a thin provisioning volume to an application which is executed by the application server; and
allocate, in a case where a write request is received from the application which is executed by the application server, a part of the first one or more of the logical units, which is associated with the storage pool, to the thin provisioning volume,
wherein the management server is configured to:
periodically obtain, from the storage device, information on the array groups, the logical units and the storage pool, the array groups correspondence relations, the logical units correspondence relations, and the storage pool correspondence relations;
associate second one or more the logical units which is not associated with the storage pool as an unused volume pool;
monitor a capacity of the storage pool based on the obtained information on the storage pool;
determine that the storage pool has run short of the capacity in a case where the capacity of the storage pool is equal to or smaller than a predetermined threshold value; and
transmit, to the storage device, an allocation request which includes an identifier of the storage pool which has run short of the capacity and an identifier of a certain logical unit which is associated with the unused volume pool, and which is to be temporarily allocated to the storage pool which has run short of the capacity;
the storage device is configured to:
allocate, in a case where the allocation request is received, the certain logical unit associated with the unused volume pool to the storage pool which has run short of the capacity based on information included in the received allocation request; and
send, to the management server, a notification that the allocation has been finished;
the management server, which has received the notification from the storage device, is configured to:
send a notification that the certain logical unit is temporarily allocated to the storage pool which has run short of the capacity; and
generate storage pool detailed information based on information on the certain temporarily-allocated logical unit and information on the first one or more logical units forming the storage pool to which the certain logical unit is temporarily allocated;
the storage pool detailed information includes physical properties of the logical units; and
the management server is configured to:
display the generated storage pool detailed information on the display;
display, on the display, a screen for judging whether or not the certain temporarily-allocated logical unit is to be associated with the storage pool;
associate the certain temporarily-allocated logical unit with the storage pool, and update the storage pool correspondence relations in a case where an instruction to allow the certain temporarily-allocated logical unit to be associated with the storage pool is received;
transmit, to the storage device, an association request which requests the certain temporarily-allocated logical unit to be associated with the storage pool;
generate a list of logical units which can be newly allocated to the storage pool, the list excluding a logical unit which has at least one physical property identical to at least one of physical properties of the certain temporarily-allocated logical unit in a case where an instruction to prohibit the certain temporarily-allocated logical unit from being associated with the storage pool is received; and
display the generated list of the certain logical units associated with the unused volume pool on the display.
